(19) United States
(12) Patent Application Publication
(10) Pub. No.: US 2025/0141587 A1
(43) Pub. Date: May 1, 2025

(54) SYSTEM-LEVEL WAVELENGTH-DIVISION MULTIPLEXED SWITCHING FOR HIGH BANDWIDTH AND HIGH-CAPACITY MEMORY ACCESS

(71) Applicant: Xscape Photonics Inc., Fort Lee, NJ (US)

(72) Inventors: Karthik Vaithianathan, New York, NY (US); Vivek Raghunathan, Mountain View, CA (US); Yoshitomo Okawachi, River Edge, NJ (US); Asher Novick, Long Island City, NJ (US)

(21) Appl. No.: 18/934,228

(22) Filed: Oct. 31, 2024

Related U.S. Application Data
(60) Provisional application No. 63/594,462, filed on Oct. 31, 2023.

(51) Int. Cl. H04J 14/02; G06F 13/20

(52) U.S. Cl. CPC H04J 14/0307; G06F 13/20; G06F 2213/16

(57) ABSTRACT

Electro-optic (“EO”) computing systems for high bandwidth and high-capacity memory access via wavelength-division multiplexed (“WDM”) switching are provided herein. Examples of the EO computing system include one or more compute circuit packages, one or more memory circuit packages, and an optical switch connected between the compute and memory circuit packages.

### CROSS REFERENCE TO RELATED APPLICATIONS

This application claims priority to U.S. Application No. 63/594,462, filed on Oct. 31, 2023, the entire contents of which are hereby incorporated by reference.

### TECHNICAL FIELD

This specification relates generally to electro-optical computing systems and system-level wavelength-division multiplexed switching for high bandwidth and high-capacity memory access in such electro-optical computing systems.

### BACKGROUND

Modern computing systems are increasingly limited by memory latency and bandwidth. While advances in silicon processing have led to improvements in computation speed and energy efficiency, memory interconnections have not kept up. Gains in memory bandwidth and latency have often required significant compromises, adding complexity in signal integrity and packaging. For instance, state-of-the-art High Bandwidth Memory (“HBM”) requires mounting memory on a silicon interposer within just a few millimeters of the client device. This setup involves pins running over electrical connections at speeds exceeding three gigahertz (“GHz”), which creates challenging and costly thermal and signal-integrity constraints. Additionally, the necessity to position memory modules near the processing chips restricts the number and arrangement of HBM stacks around the client device and limits the total memory that can be integrated into such systems.

Silicon photonics devices are photonic devices that utilize silicon as an optical transmission medium. Semiconductor fabrication techniques can be exploited to pattern the photonic devices, achieving sub-micron, e.g., nanometer, precision. Because silicon is utilized as a substrate for most electronic integrated circuits (“EICs”), silicon photonic devices can be configured as hybrid electro-optical devices that integrate both electronic and optical components onto a single microchip or circuit package. Silicon photonic devices can also be used to facilitate data transfer between microprocessors, a capability of increasing importance in modern networked computing.

### SUMMARY

This specification describes electro-optical (“EO”) computing systems and system-level wavelength-division multiplexed switching for high bandwidth and high-capacity memory access in such EO computing systems. In general, the EO computing systems include one or more compute circuit packages, one or more memory circuit packages, and an optical switch coupled between the compute and memory circuit packages.

The EO computing systems described herein can achieve reduced power consumption, increased processing speed (e.g., reduced latency), and exceeding high bandwidth and capacity for accessing memory. Such capabilities are enabled, at least in part, by segmenting the processing tasks in the electronic domain and memory access tasks in the optical domain. For example, each compute and memory circuit package can include a number of compute or memory modules that are optimized for performing processing or memory access tasks locally, and can be modified with EO interfaces for performing high bandwidth data transfer tasks remotely. The optical switch is an integrated photonic device, e.g., a photonic integrated circuit (“PIC”) such as a silicon PIC (“SiPIC”), that includes a network of optical waveguides and wavelength-selective filters. The optical switch provides configurable switching and routing optical communications between the circuit packages with near zero latency, e.g., limited by time-of-flight. The described architectures of the optical switch are versatile and scalable and enable integration of remote circuit packages via optical fiber.

The EO computing systems described herein can be applied to a wide range of processing tasks that involve considerable compute, memory capacity, and bandwidth, but are particularly adept at implementing machine learning models, e.g., neural network models. For example, training a large language model (“LLM”) with hundreds of billions of parameters can involve trillions of floating-point operations per second (“TFLOPS”). The EO computing systems can integrate high-end processors, e.g., Central Processing Units (“CPUs”), Graphics Processing Units (“GPUs”), and/or Tensor processing units (“TPUs”), on the compute circuit package(s) capable of several hundred TFLOPS in parallel across hundreds, thousands, tens of thousands, or hundreds of thousands of compute modules. Moreover, the EO computing systems can integrate high-end memory devices, e.g., Double Data Rate (“DDR”), Graphics DDR (“GDDR”), Low-Power DDR (“LPDDR”), High Bandwidth Memory (“HBM”), Dynamic Random-Access Memory (“DRAM”), and/or Reduced-Latency DRAM (“RLDRAM”), on the memory circuit package(s) capable of storing each parameter of the model (e.g., weights and biases) in memory with high bandwidth access. For example, implementations of the EO computing systems described herein can provide a bisection bandwidth of at least about 1 petabit per second (“Pb/s”), 2 pbs, 3 pbs, 4 pbs, 5 pbs, 6 pbs, 7 bps, 8 pbs, 10 pbs, 15 pbs, 20 pbs, 25 pbs, 30 pbs, 35 pbs, 40 pbs, 45 pbs, 50 pbs, or more, and a memory capacity of at least about 1 terabyte (“TB”), 2 TB, 3 TB, 4 TB, 5 TB, 6 TB, 7 TB, 8 TB, 10 TB, 15 TB, 20 TB, 25 TB, 30 TB, 35 TB, 40 TB, 45 TB, 50 TB, 75 TB, 100 TB, or more.

Neural networks typically consist of one or more layers that calculate neuron output activations by performing weighted summations, such as Multiply-Accumulate (MAC) operations, on a set of input activations. For any given neural network, the transfer of activations between its nodes and layers is usually predetermined. Additionally, once the training phase is complete, the neuron weights used in the summation, along with any other activation-related parameters, remain fixed. Therefore, the EO computing systems described herein are well-suited for implementing a neural network by mapping network nodes to compute modules, pre-loading the fixed weights into memory modules, and configuring the optical switch for data routing between compute and memory modules according to the pre-established activation flow.

These and other feature related to the EO computing systems described herein are summarized below.

In one aspect, a memory module is described. The memory module includes: a memory; and an electro-optical memory interface including: an optical IO port; a memory controller electrically coupled to the memory via a data bus; and an electro-optical interface protocol electrically coupled to the memory controller and optically coupled to the optical IO port, where the electro-optical interface protocol is configured to: receive, from the memory controller, a memory data stream including data stored on the memory; impart the memory data stream onto a multiplexed optical signal; and output the multiplexed optical signal at the optical IO port.

In some implementations of the memory module, the electro-optical interface protocol includes: a digital electrical layer configured to serialize the memory data stream into a plurality of bitstreams; and an analog electro-optical layer configured to: receive, from the digital electrical layer, the plurality of bitstreams; impart each bitstream onto a respective optical signal having a different wavelength; and multiplex the optical signals into the multiplexed optical signal.

In some implementations of the memory module, the analog electro-optical layer includes: an analog optical layer including a respective optical modulator for each wavelength; and an analog electrical layer including a respective modulator drive electrically coupled to each optical modulator.

In some implementations of the memory module, the memory includes a plurality of memory ranks each including a plurality of memory chips.

In some implementations, the memory module further includes: a plurality of multiplexers each associated with a respective subset of the plurality of memory ranks, each multiplexer including: a plurality of input buses each electrically coupled to an output bus of a corresponding memory rank in the subset of memory ranks for the multiplexer; and an output bus electrically coupled to the data bus.

In some implementations of the memory module, each of the plurality of memory ranks has an output bus of a same bit width, and the memory module further includes: a clock generation circuit configured to generate a respective clock signal for each of the plurality of memory ranks; a plurality of mixers each associated with a respective bit position, each mixer including: a plurality of input bits each electrically coupled to an output bit of a corresponding one of the plurality of memory ranks at the bit position for the mixer; and an output bit electrically coupled to the data bus.

In some implementations of the memory module, each memory chip is a LPDDRx memory chip or a GDDRx memory chip.

In some implementations of the memory module, the memory includes eight or more memory ranks.

In some implementations, the memory module has a DIMM form factor.

In some implementations, the memory module includes a printed circuit board having the memory and electro-optical memory interface mounted thereon.

In some implementations, the memory module has a bandwidth of 1 terabyte per second (TB/sec) or more.

In a second aspect, an electro-optical computing system is described. The electro-optical computing system includes: an optical switch including a first set of optical IO ports and a second set of optical IO ports, wherein the optical switch is configured to: receive, from any one optical IO port in the first set, a multiplexed optical signal including a respective optical signal at each of a plurality of wavelengths; and independently route each optical signal in the multiplexed optical signal to any one optical IO port in the second set; and a plurality of memory modules each including: a memory; and an electro-optical memory interface including: an optical IO port optically coupled to a corresponding one of the optical IO ports of the second set; a memory controller electrically coupled to the memory; and an electro-optical interface protocol electrically coupled to the memory controller and optically coupled to the optical IO port.

In some implementations, the electro-optical computing system further includes: a plurality of compute modules each including: a host; and an electro-optical host interface including: an optical IO port optically coupled to a corresponding one of the optical IO ports of the first set; a link controller electrically coupled to the host; and an electro-optical interface protocol electrically coupled to the link controller and optically coupled to the optical IO port.

In some implementations of the electro-optical computing system, the optical switch is further configured to: receive, from any one optical IO port in the first set, a multiplexed optical signal including a respective optical signal at each of the plurality of wavelengths; and independently route each optical signal in the multiplexed optical signal to any one optical IO port in the second set.

Particular embodiments of the subject matter described in this specification can be implemented so as to realize one or more of the following advantages.

The demand for artificial intelligence (“AI”) computing, especially for machine learning (“ML”) and deep learning (“DL”), is increasing at a pace that current processing and data storage capacities are incapable of meeting. This rising need, alongside the growing complexity of AI models, calls for computing systems that link multiple processors and memory devices, allowing rapid, low-latency data exchange between them. This specification provides various system-level integrations of electro-optical (“EO”) computing systems that answer this call. The EO computing systems employ a fiber and optics interface to link memory requesters with the memory controller embedded in the memory module via an optical switch. This optical switch has no latency apart from the inherent time-of-flight, as there are no buffers along the switching path. This design allows a memory requester to connect to multiple memory controllers simultaneously, enabling access to memory modules without compromising between capacity and throughput. Integrating the optical switch at the system level significantly boosts memory bandwidth from tens or hundreds of gigabytes per second to terabytes per second (or even petabytes). This is achieved by adapting the current electrical interfaces of memory modules for optical data transmission, allowing data read and write operations to bypass the clocking, impedance, signal loss, and other constraints typically associated with electrical signal transmission over conductive (e.g., copper) interfaces between the memory modules and the memory controller.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a schematic diagram depicting an example of a compute circuit package (or “XPU”) including a number of compute modules.

FIG. 1B is a schematic diagram depicting an example of a memory circuit package (or “MEM”) including a number of memory modules and a primitive execution module.

FIG. 2A is a schematic diagram depicting an example of a compute module including a host and an electro-optical (“EO”) host interface providing an optical input/output (“IO”) port for the host.

FIG. 2B is a schematic diagram depicting an example of a memory module including a memory and an EO memory interface providing an optical IO port for the memory.

FIG. 3A is a schematic diagram depicting an example of an EO interface protocol.

FIG. 3B is a schematic diagram depicting an example of a EO physical analog layer of an EO interface protocol.

FIG. 3C is a schematic diagram depicting another example of an EO interface protocol including multiple optical IO ports.

FIG. 4A is a schematic diagram depicting an example of a memory read request circuit for performing rank interleaving during memory read requests of a memory.

FIG. 4B is a schematic diagram depicting an example of a memory write request circuit for performing rank interleaving during memory write requests of a memory.

FIG. 4C is a schematic diagram depicting another example of a memory read request circuit for combining memory ranks using phase-shifted clocks.

FIG. 5A is a schematic diagram depicting an example of an EO computing system including one or more compute circuit packages, one or more memory circuit packages, and an optical switch.

FIGS. 5B-5D are schematic diagrams depicting different switching layers of the optical switch of the EO computing system shown in FIG. 5A.

FIG. 6 is a schematic diagram depicting another example of an EO computing system configured with a variable number of optical IO ports for each module of the EO computing system.

FIG. 7 is a schematic diagram depicting an example of an optical switch based on wavelength-selective filters.

FIG. 8 is a schematic diagram depicting an example of an add-drop filter based on a ring resonator.

FIG. 9 is a schematic diagram depicting another example of an add-drop filter based on a ring resonator.

FIG. 10 is a schematic diagram depicting another example of an optical switch based on wavelength-selective filters.

FIG. 11 is a schematic diagram depicting an example of a channel mixer of the optical switch shown in FIG. 10.

FIG. 12 is a schematic diagram depicting another example of an optical switch in a Clos network topology.

Like reference numbers and designations in the various drawings indicate like elements.

### DETAILED DESCRIPTION

### I. Introduction

Electrical interfaces impose limits on the bandwidth, the capacity, or both, for memory that is accessible by processors, circuits, and other devices of a computing system. For instance, Double Data Rate (“DDR”), Graphics DDR (“GDDR”), Low-Power DDR (“LPDDR”), High Bandwidth Memory (“HBM”), and other memory technologies are implemented with different tradeoffs between capacity (e.g., the size of accessible memory per memory module) and throughput (e.g., the bandwidth with which the memory may be accessed). The limitations may be due in part to the clocking (e.g., frequency), impedance, signal loss, and/or other transmission properties of the electrical interface that connects the memory controller to each memory module. If the capacity is increased on a given data bus, e.g., due to increased fan-out, the capacitive load increases resulting in loss of signal quality. Thus, for a given memory controller, the data bus cannot be run beyond a certain trace distance. If an electrical switch is used before the memory controller, e.g., a Compute Express Link (“CXL”) switch, and the input to this electrical switch is serialized or packetized data, then the memory access latency increases, e.g., from decoding the packet header and routing the packet to its intended destination.

To overcome some, or all, of these abovementioned challenges, this specification provides various system-level integrations of electro-optical (EO) computing systems that utilize a fiber and optics interface to connect memory requesters to the memory controller integrated with the memory module through an optical switch. The optical switch has zero latency (besides the time-of-flight) as there are no buffers through the switching path. Therefore, the optical switch allows a memory requester to fan-out to multiple memory controllers to access the memory modules without trading off capacity for throughput, or vice versa. The system-level integrations of the optical switch significantly increase memory bandwidth from tens or hundreds of gigabytes per second to terabytes per second (or even petabytes) by converting the existing electrical interfaces of existing memory modules for optical data transmission such that the reading and writing of data to and from the memory modules occurs without the clocking, impedance, signal loss, and/or other limitations associated with transmission of electrical signals over a conductive (e.g., copper) interface between the memory modules and the memory controller. For example, the optical switch can be placed between the memory requestor and the memory module integrated with a memory controller and memory devices or between the memory controller part of the host and the memory module with plain memory devices. In some implementations, the optical switch can be configurable and may dynamically change the width and customize the capacity of address ranges. In such implementations, the configurable optical switch may provide different processors access to different address ranges that are mapped to different channels of the accessible memory.

Different system-level implementations of the EO computing systems are provided herein for different memory modules that support different capacities, channel sizes for compatibility with different processors, e.g., 32-bit or 64-bit aligned words for general processors and 256-bit or 512-bit aligned words for specialized artificial intelligence and graphics processors. The system-level integrations include optical modulators between the memory controller and the memory modules. The optical modulators perform different wavelength modulation and multiplexing depending on the channel width, number of ranks, capacity per channel, supported rank interleaving, and/or other properties associated with the memory devices.

For example, for memory modules supporting 128 bits per channel at a per pin maximum frequency of 8 gigabits per second (“Gbps”) and rank interleaving, the optical modulators may receive 128 data bits and 32 control bits from each channel for a total of 1.28 terabits per seconds (“Tbps”). The optical modulators may map each channel to a different fiber resulting in four fibers per memory module for a total bandwidth of 5.12 Tbps. For memory modules that support four ranks per module with 128 bits per channel, the optical modulator may map each rank to a different channel without interleaving with each of the four ranks activated in parallel or simultaneously, and each channel from each rank may be mapped to a different optical fiber. The optical modulators support similar channel-to-fiber mapping for memory modules with different sized channels (e.g., 64 bits per channel), different memory capacities, or different maximum frequency supported per pin of the memory module.

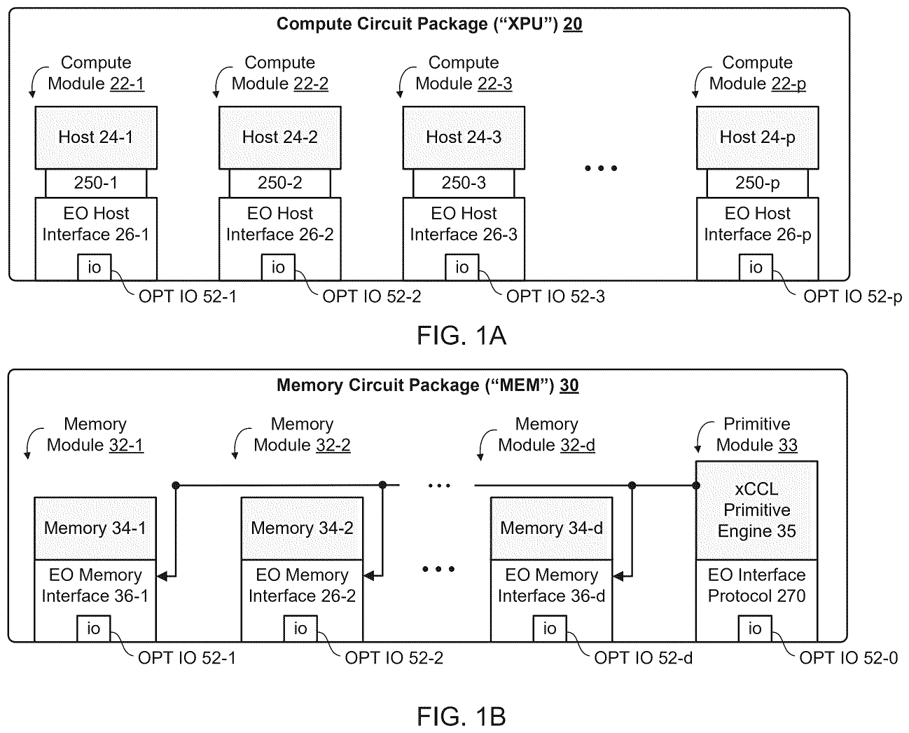

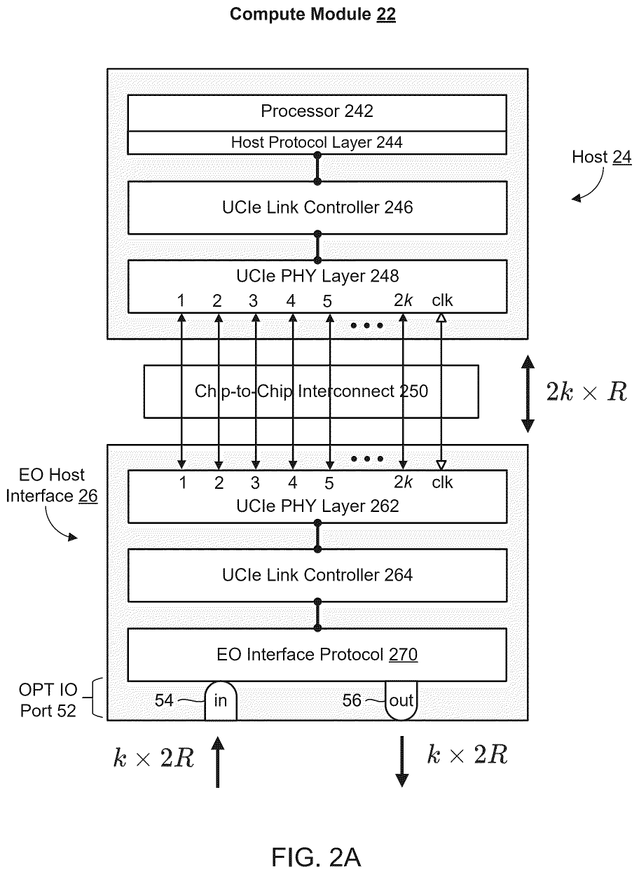

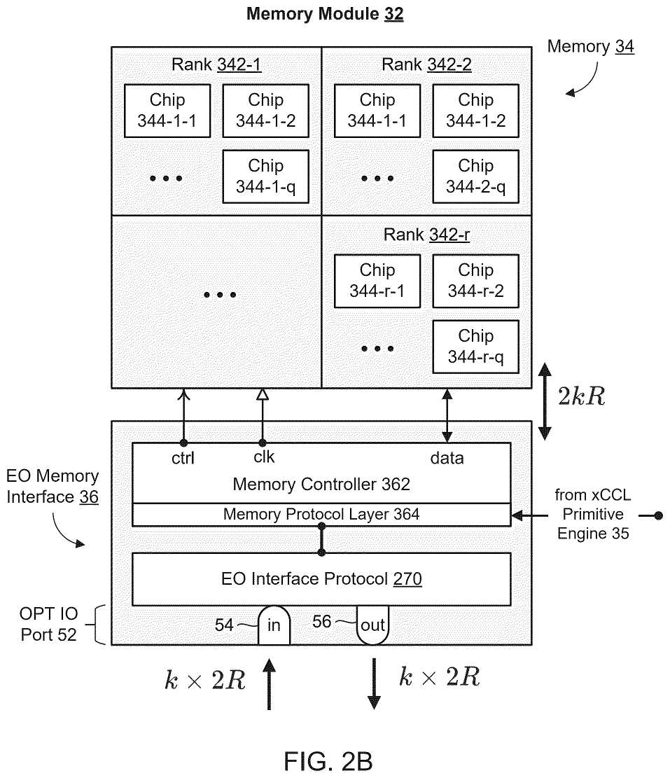

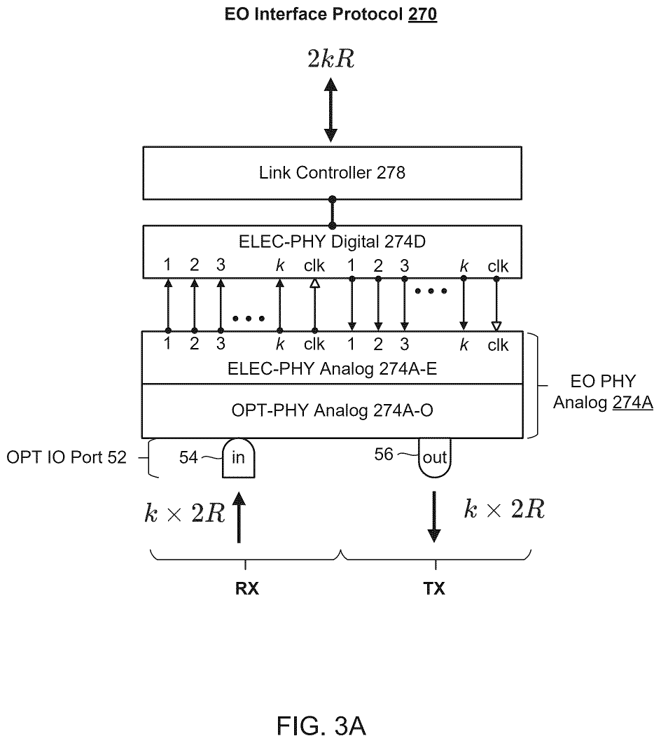

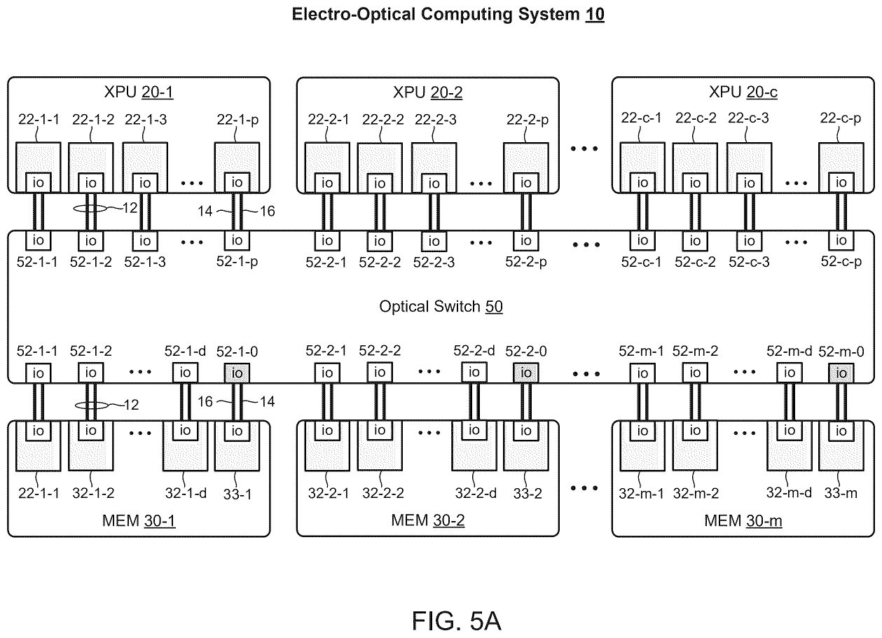

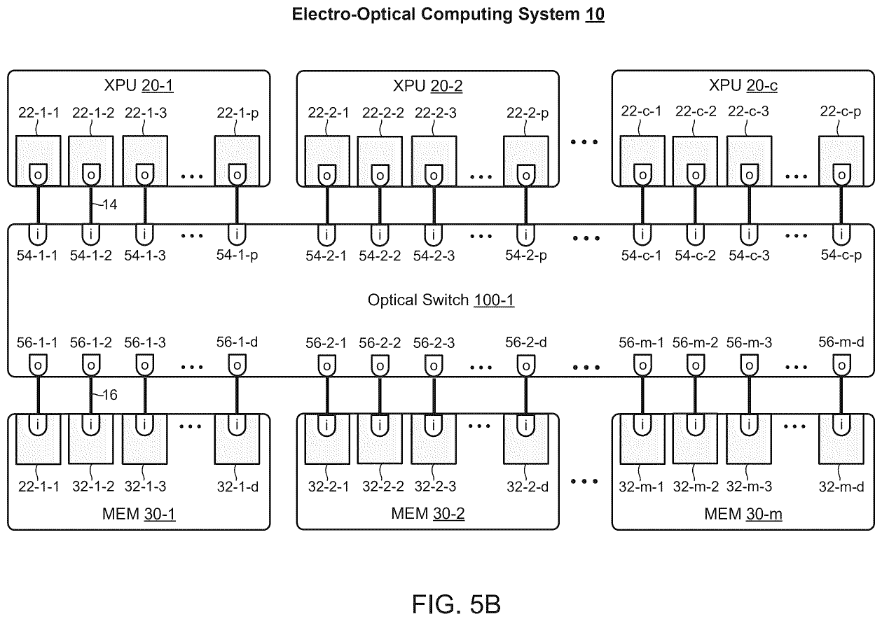

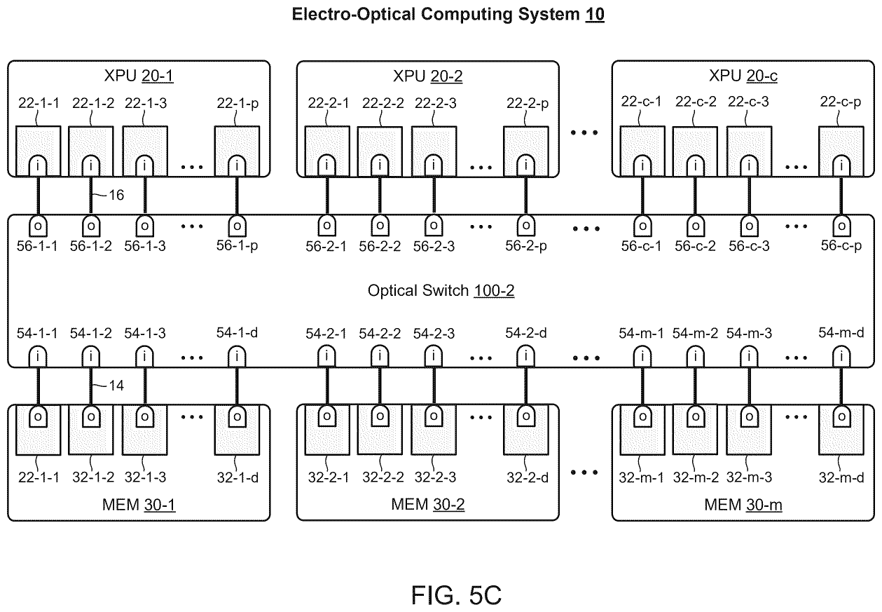

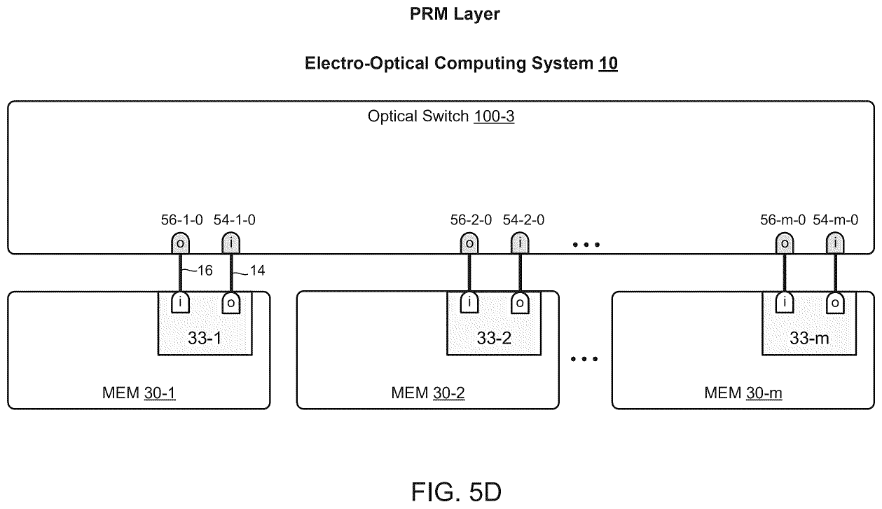

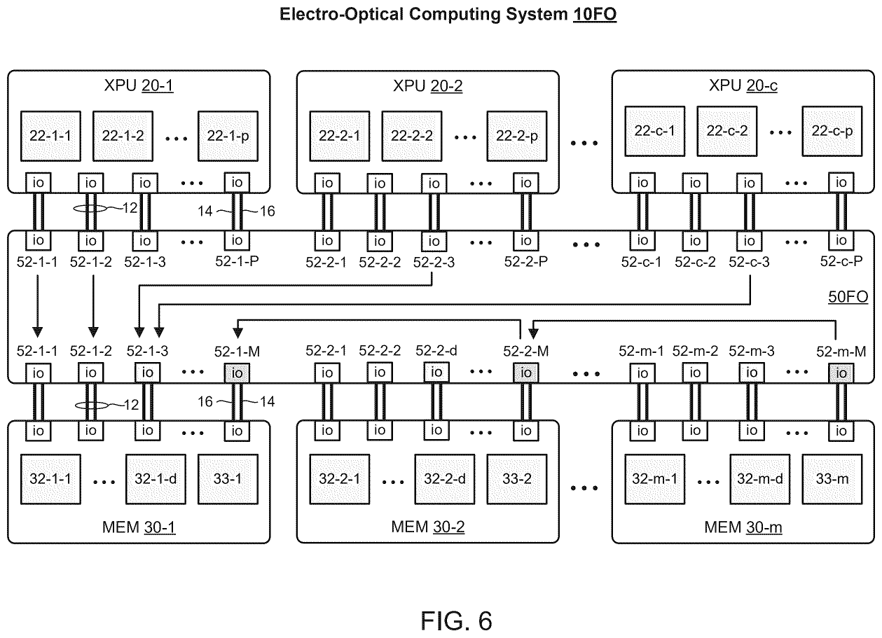

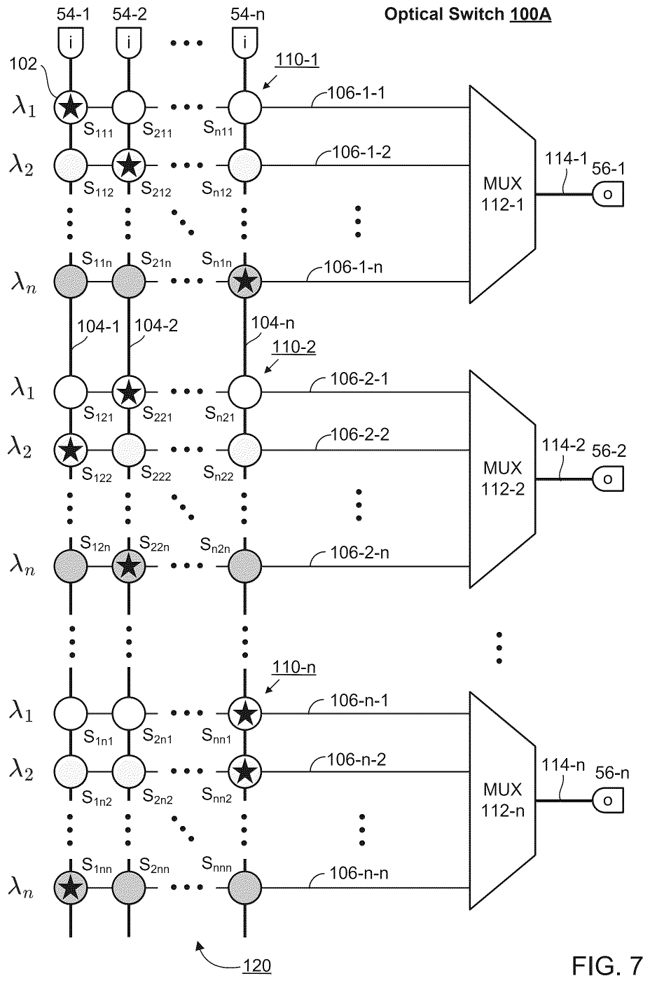

Package-level architectures of the compute and memory circuit packages are presented in FIGS. 1A-1B. Chip-level architectures of the compute and memory modules are presented in FIGS. 2A-4C. System-level architectures of the EO computing system and the optical switch are presented in FIGS. 5A-6. Circuit-level architectures for one or more switching layers of the optical switch are presented in FIGS. 7-12. These features and other features are described in more detail below.

### II. Examples of Compute and Memory Circuit Packages

FIG. 1A is a schematic diagram depicting an example of a compute circuit package 20, e.g., a system-in-package (“SiP”), including a number (p) of compute modules 22-1 to 22-p. For example, the compute circuit package 20 can include 1, 2, 3, 4, 5, 6, 7, 8, 9, 10, 11, 12, 13, 14, 15, 16, 32, 64, 128, 256, 512, 1024, or more compute modules 22. For sake of brevity, a compute circuit package 20 will also be referred herein as a “XPU”. Among other data processing applications, the XPU 20 can be configured as a machine learning processor or a machine learning accelerator, e.g., where the compute modules 22-1 to 22-p compute neuron output activations for a set of input activations of a neural network. As shown in FIG. 1A, each compute module 22 includes a host 24 and an EO host interface 26 providing an optical input/output (“IO”) port 52 for the host 24 (see FIG. 2A for a more detailed example of a compute module 22). In general, the IO port 52 includes an optical input port 54 and an optical output port 56 that can each be attached to an optical fiber or waveguide. The optical input port 54 is configured to receive multiplexed input signals, while the optical output port 56 is configured to transmit multiplexed output signals. For example, the optical input 54 and output 56 ports can each include a fiber attach unit (“FAU”), a grating coupler, an edge coupler, or any appropriate optical connector.

The hosts 24-1 to 24-p and EO host interfaces 26-1 to 26-p of the compute modules 22-1 to 22-p can be implemented as individual chips (or chiplets) that can be attached to a substrate of the XPU 20 via adhesives, solder bumps, junctions, mechanically, or other bonding techniques. The host 24 and EO host interface 26 of each compute module 22 are electrically connected to each other by a chip-to-chip interconnect 250. The chip-to-chip interconnects 250-1 to 250-p can be provided by the XPU 20 or formed thereon when assembling the XPU 20. For example, the chip-to-chip interconnects 250-1 to 250-p can be implemented via a silicon interposer or an organic interposer serving as the substrate of the XPU 20, an embedded multi-die interconnect bridge (“EMIB”) formed in the substrate of the XPU 20, through-silicon vias (“TSVs”) formed in the substrate of the XPU 20, one or more High Bandwidth Interconnects (“HBI”), or micro-bump bonding.

Using a chip-to-chip interconnect 250, such that the host 24 and EO host interface 26 of a compute module 22 are implemented as separate chips, provides a number of advantages including increased modularity and bandwidth variability, as well as effectively converting the electrical interfaces of the host 24 into optical interfaces without altering any protocols or applications performed by the host 24. For example, the EO host interface 26 can be substituted with a different EO host interface that provides a different bandwidth, a different bandwidth per channel, and/or a different number of IO ports 52 as desired, see FIGS. 6-8 for example. The EO host interface 26 can be an electro-photonic chiplet that combines both electronic and photonic components on a single chip, e.g., a silicon chip, to convert between electrical and optical signals.

FIG. 1B is a schematic diagram depicting an example of a memory circuit package 30, e.g., a SiP, including a number (d) of memory modules 32-1 to 32-d and a primitive execution module 33. For example, the memory circuit package 30 can include 1, 2, 3, 4, 5, 6, 7, 8, 9, 10, 11, 12, 13, 14, 15, 16, 32, 64, 128, 256, 512, 1024, or more memory modules 32. For sake of brevity, a memory circuit package 30 will also be referred herein as a “MEM” for short. Among other data storage applications, the MEM 30 can be configured as a high bandwidth, high-capacity memory for a machine learning processor or a machine learning accelerator, e.g., where the memory modules 31-1 to 32-d are loaded with weights associated with a neural network, e.g., that may be updated during training of the neural network. As shown in FIG. 1B, each memory module 32 includes a memory 34 and an EO memory interface 36 providing an IO port 52 for the memory 34 (see FIG. 2B for a more detailed example of a memory module 32). In general, the IO port 52 includes an optical input port 54 and an optical output port 56 that can each be attached to an optical fiber or waveguide. As above, the optical input port 54 is configured to receive multiplexed input signals, while the optical output port 56 is configured to transmit multiplexed output signals. For example, the optical input 54 and output 56 ports can each include a FAU, a grating coupler, an edge coupler, or any appropriate optical connector.

The primitive execution module 33 includes an xCCL primitive engine 35 and an EO interface protocol 270 providing an IO port 52-0 for the xCCL primitive engine 35. The xCCL primitive engine 35 is configured with a collective communications library (“xCCL”) for facilitating collective communications and executing primitive commands. For example, the xCCL primitive engine 35 can be configured with the NVIDIA® Collective Communications Library (“NCCL”), the Intel® oneAPI Collective Communications Library (“oneCCL”), the Advanced Micro Devices® ROCm Collective Communication Library (“RCCL”), the Microsoft® Collective Communication Library (“MSCCL”), the Alveo Collective Communication Library, or Gloo.

The memory modules 32-1 to 32-d are implemented as complete, individual units that can be attached or otherwise mounted to a substrate of the MEM 30, e.g., via adhesives, solder bumps, junctions, mechanically, or other bonding techniques. For example, in some implementations, each memory module 32 can be implemented as a Dual Inline Memory Module (“DIMM”) that provides the memory 34 on a printed circuit board (“PCB”), and the EO memory interface 36 is integrated onto the circuit board, e.g., soldered or pressed into electrical junctions. This provides a so-called High Bandwidth Optical DIMM (“HBODIMM”) as the memory module 32 is configured to receive and transmit optical signals for accessing memory. The primitive execution module 33 can be implemented as a single chip (or chiplet) that can be attached to the substrate of the MEM 30 via adhesives, solder bumps, junctions, mechanically, or other bonding techniques. The xCCL primitive engine 35 of the primitive execution module 33 is electrically connected to the EO memory interface 36 of each memory module 32-1 to 32-d, e.g., via one or more chip-to-chip interconnects or other conductive pathways in the MEM 30's substrate. Examples of chip-to-chip interconnects for the memory modules 32-1 to 32-d and the primitive execution module 33 on the MEM 30 include any of those described above for the compute modules 22-1 to 22-p on the XPU 20.

### III. Examples of Compute and Memory Modules

FIG. 2A is a schematic diagram depicting an example of a compute module 22 including a host 24 and an EO host interface 26 providing an IO port 52 for the host 24. The EO host interface 26 is electrically coupled to the host 24 and can be optically coupled to an external optical device, e.g., an optical switch 50, via the IO port 52 to enable the conversion of electrical and optical signals therebetween. Here, the host 24 and EO host interface 26 are configured with the Universal Chiplet Interconnect Express (“UCIe”) specification for facilitating a chip-to-chip interconnect 250 and serial bus between the host 24 and EO host interface 26. UCIe is advantageous for supporting large SoC packages that exceed recital size and allowing intermixing of components from different silicon vendors. However, other chiplet interconnect specifications may also be used for the host 24 and EO host interface 26 such as the Peripheral Component Interconnect Express (“PCIe”) specification, Intel® Ultra Path Interconnect (“UPI”) specification, Compute Express Link (“CXL”) specification, AMD® Infinity Fabric, Open Coherent Accelerator Processor Interface (“OpenCAPI”), or the Arm® Advanced Microcontroller Bus Architecture (“AMBA”) interconnect specification.

The host 24 includes a processor 242, a host protocol layer 244 implemented as software running on the processor 242's operating system or firmware, a UCIe link controller 246, and a UCIe physical (“PHY”) layer 248. The processor 242 performs the data processing tasks for the compute module 22. For example, the processor 242 can be a Central Processing Unit (“CPU”), a Graphics Processing Unit (“GPU”), a Tensor Processing Units (“TPU”), a Neural Processing Unit (“NPU”), an eXtreme Processing Unit (“xPU”), an Application-Specific Integrated circuit (“ASIC”), or a Field-Programmable Gate Array (“FPGA”). The host protocol layer 244, UCIe link controller 246, and UCIe PHY layer 248 manage electrical data transmission from the host 24 to the EO host interface 26 over the die-to-to-interconnect 250. The host protocol layer 244 is responsible for managing communication between the UCIe link controller 246 and applications performed by the processor 242. For example, the host protocol layer 244 can include on-chip communication bus protocols such as the Advanced eXtensible Interface (“AXI”) or AMD® Infinity Fabric. The UCIe link controller 246 manages the link layer protocols and is responsible for framing, addressing, and error detection for data packets being transmitted over the chip-to-chip interconnect 250. The UCIe PHY layer 248 is responsible for the physical transmission of raw bits over the die-to-to interconnect 250 and defines the electrical signals used for data transmission.

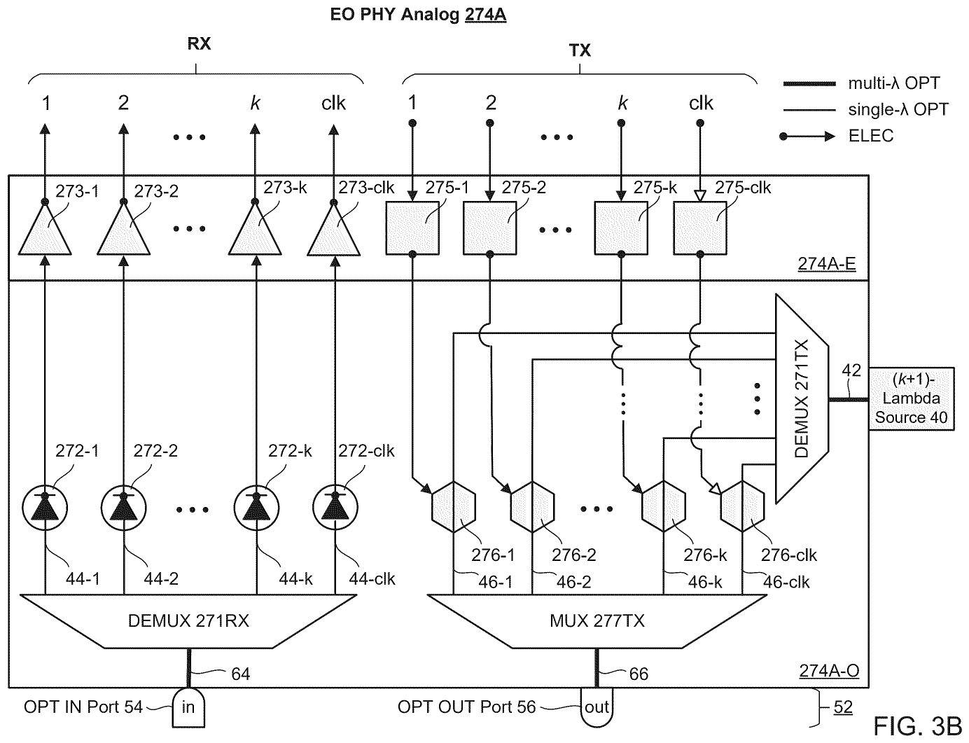

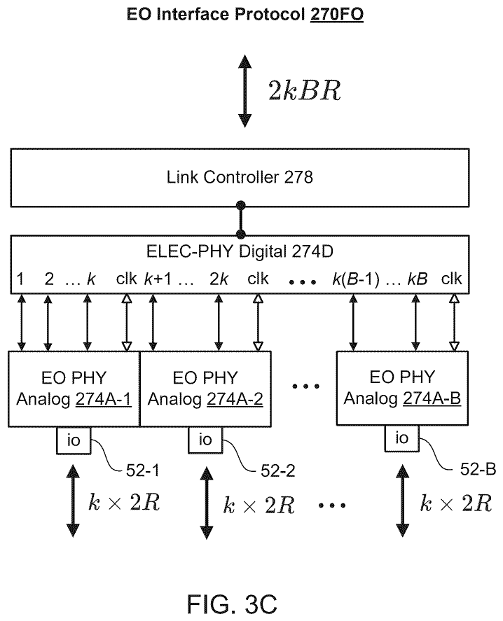

The EO host interface 26 includes a UCIe PHY layer 262, a UCIe link controller 264, an EO interface protocol 270, and the IO port 52. The UCIe PHY layer 262 and UCIe link controller 246 perform the same functions for the EO interface protocol 270 as that described above for the host 24. The EO interface protocol 270 manages data transmission between the UCIe link controller 246 and the IO port 52. Particularly, the EO interface protocol 270 is responsible for converting between optical signals transmitted (or received) at the IO port 52 and electrical signals received from (or transmitted to) the UCIe link controller 246. An example of the EO interface protocol 270 is shown in FIG. 3A and described in more detail below.

As shown in FIG. 2A, the chip-to-chip interconnect 250 supports 2k-bidirectional (“bidi”) channels (or lanes) between the host 24 and EO host interface 26, each at a bidi bitrate of R, as well as a receive (“RX”) and transmission (“TX”) clk signal between the two. Thus, the chip-to-chip-interconnect 250 has a bidi bandwidth of 2kR. The IO port 52 includes an optical input port 54 and an optical output port 56 that together support two k-unidirectional (“unidi”) data channels between the EO host interface 26 and an external optical device, e.g., an optical switch 50. The optical input port 54 supports k-unidi (serialized) data channels and a clock channel in RX, while the optical output port 56 supports k-unidi (serialized) data channels and a clock channel in TX. Each k-unidi data channel is configured at a unidi bit rate of 2R and the two clock channels are configured at a clock rate (e.g., frequency) of f. Thus, the IO port 52 has a bidi bandwidth of 2kR. For example, for sixteen data channels k=16 and a bidi bitrate of R=32 Gbps, the IO port 52 has a bidi bandwidth of 1024 Gbps (1 Tbps) and can have a clock rate of 16 gigahertz (“GHz”).

FIG. 2B is a schematic diagram depicting an example of a memory module 32 including a memory 34 and an EO memory interface 36 providing an IO port 52 for the memory 34. The EO memory interface 36 is electrically coupled to the host 24 and can be optically coupled to an external optical device, e.g., an optical switch 50, via the IO port 52 to enable the conversion of electrical and optical signals therebetween.

The memory 34 includes one or more memory devices providing a number (r) of memory ranks 342-1 to 342-r. For example, the memory 34 can include 1, 2, 3, 4, 5, 6, 7, 8, 9, 10, 11, 12, 13, 14, 15, 16, 32, 64, 128, 256, or more memory ranks 342. Each memory rank 342-1 to 342-r includes a number (q) of memory chips 344-1 to 344-q connected to a same chipset and, therefore, can be accessed simultaneously. For example, each memory rank 342-1 to 342-r can include 1, 2, 3, 4, 5, 6, 7, 8, 9, 10, 11, 12, 13, 14, 15, 16, 32, 64, 128, 256, or more memory chips 344. In general, the memory ranks 342-1 to 342-r can correspond to one or more single-rank memory devices, one or more multi-rank memory devices, or one or more single-rank and multi-rank memory devices. Examples of memory devices that can be implemented as the memory 34 include, but are not limited to, Double Data Rate (“DDR”), Graphics DDR (“GDDR”), Low-Power DDR (“LPDDR”), High Bandwidth Memory (“HBM”), Dynamic Random-Access Memory (“DRAM”), and Reduced-Latency DRAM (“RLDRAM”). For example, each of the memory chips 344 can be a DDRx memory chip, a GDDRx memory chip, or a LPDDRx memory chip,

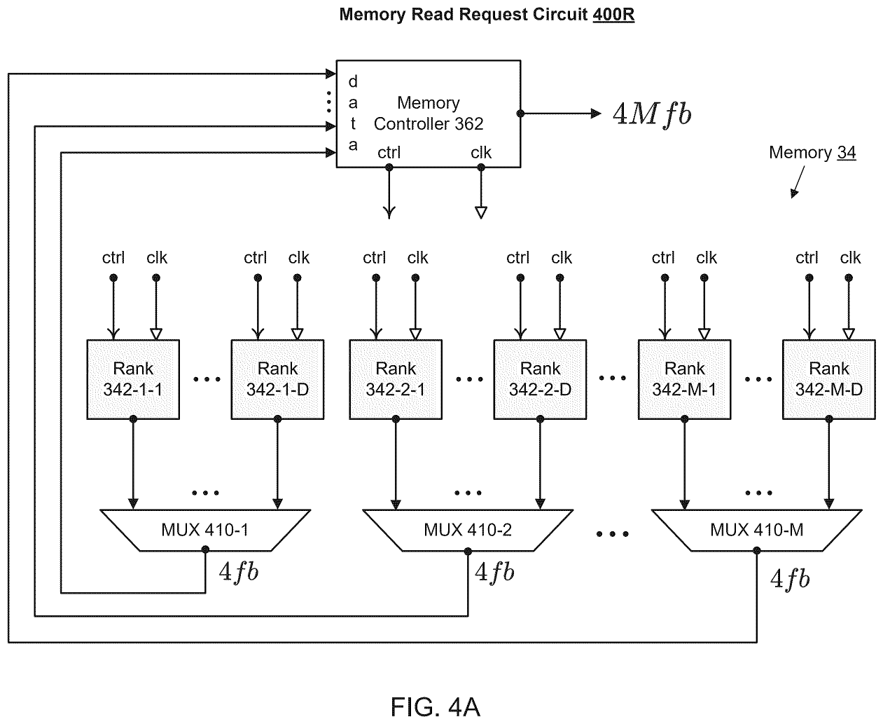

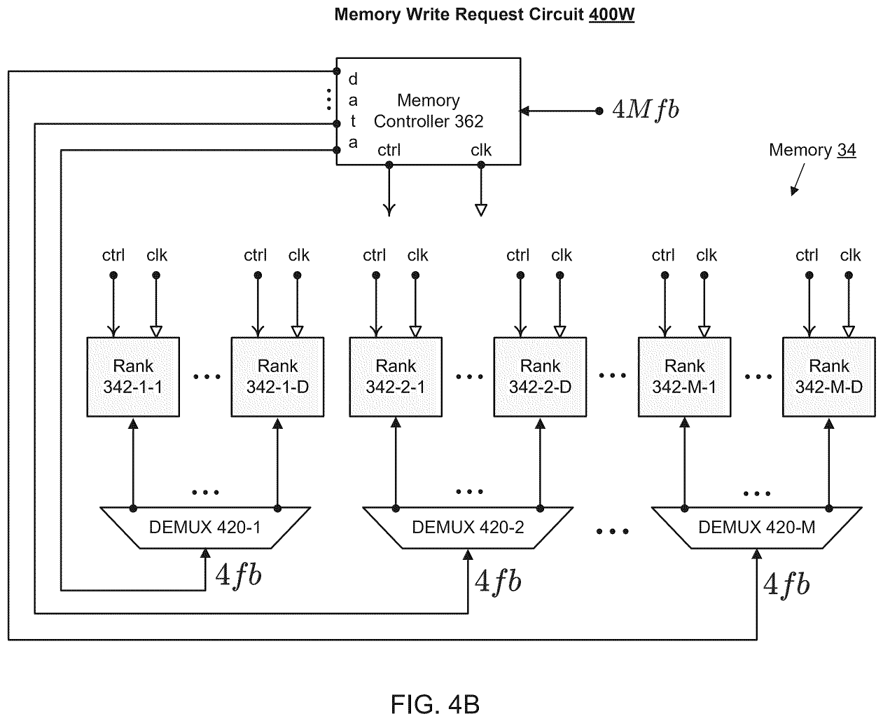

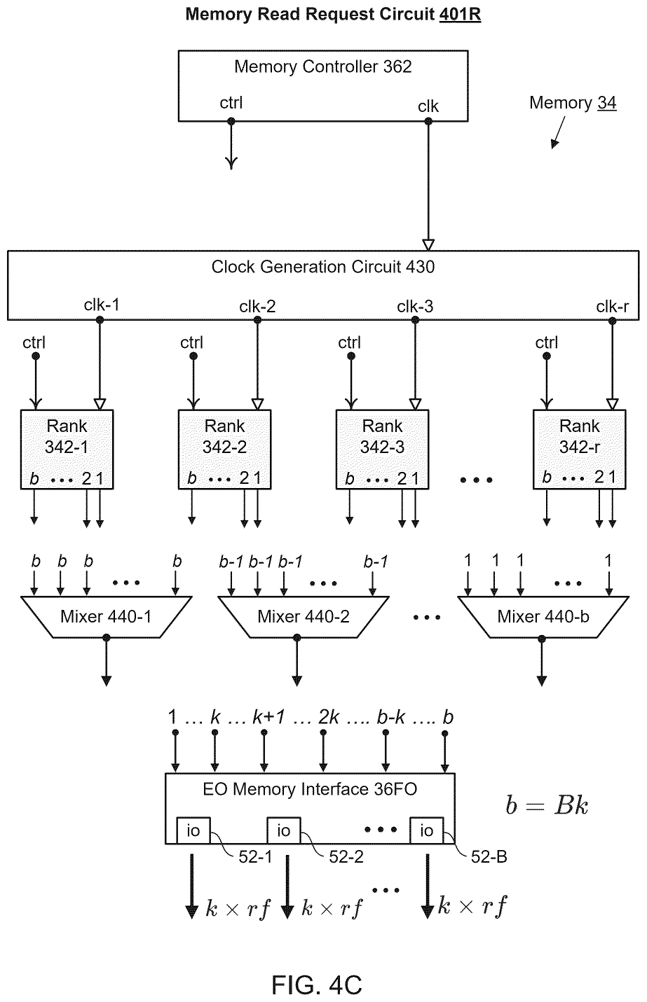

As mentioned above, in some implementations, the memory module 32 is configured as a DIMM, i.e., a HBODIMM, where the memory chips 344 and the EO memory interface 36 are mounted onto the PCB of the DIMM. In these cases, the HBODIMM 32 can include one memory rank 342 (single-rank), two memory ranks 342 (dual-rank), four memory ranks 342 (quad-rank), or eight memory ranks 342 (octal-rank). The HBODIMM 32 can have the same formfactor as an industry standard DIMM. The standard DIMM form factor is 133.35 millimeters (“mm”) in length and 30 mm in height, and the connector interface to the PCB of a DIMM has 288 pins including power, data, and control. The HBODIMM 32 can be one-sided or dual-sided, e.g., including eight memory chips 344 on one-side or eight memory chips 344 on both sides (for a total of sixteen chips). These configurations of the HBODIMM 32, when combined with the circuit topologies and methods shown in FIGS. 4A-4C, can offer 1 TB/sec or more of bandwidth, e.g., 2 TB/sec or more, e.g., 3 TB/sec or more, 4 TB/sec or more, or 5 TB/sec or more of bandwidth.

The EO memory interface 36 includes a memory controller 362, a memory protocol layer 364 implemented as software running on the memory controllers 362's operating system or firmware, an EO interface protocol 270, and the IO port 52. The EO interface protocol 270 manages data transmission between the memory controller 362 and the IO port 52. Particularly, the EO interface protocol 270 is responsible for converting between optical signals transmitted (or received) at the IO port 52 and electrical signals received from (or transmitted to) the memory controller 362. The electric signals received by the memory controller 362 generally include memory access requests specifying addresses where data needs to be read or written in the memory 34. The memory controller 362 translates these addresses into the specific row, column, bank, and rank within the memory 34. The memory protocol layer 364 defines the rules and processes for how data is transmitted between the memory controller 362 and the memory 34. For example, the memory protocol layer 364 can include on-chip communication bus protocols such as AXI or AMD® Infinity Fabric.

### IV. Examples of Electro-Optical Interface Protocols

FIG. 3A is a schematic diagram depicting an example of an EO interface protocol 270. The EO interface protocol 270 includes a link controller 278, a physical digital electrical layer (“ELEC-PHY”) layer 274D, and a physical analog electro-optical (“EO PHY”) layer 274. In general, the EO interface protocol 270 uses k wavelengths as data channels for optically transmitting and receiving data signals, and one additional wavelength as a clock channel for optically transmitting a clock (“clk”) signal, where the k+1 channels are multiplexed together for simultaneous transmission or reception via the IO port 52, e.g., through a single optical fiber or waveguide. For example, k can be any integer greater than or equal to 2. That is, k can be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 64, 128, or more. In some cases, k can be equal to k=2^{b}, where b is any integer greater than or equal to 1. For example, k can be equal 2, 4, 8, 16, 32, 64, or 128. The k+1 different wavelengths can be discretely spaced within any desired optical wavelength band including, but not limited to: the Original (“O”) Band from 1260 nanometers (“nm”) to 1360 nm; the Extended (“E”) Band from 1350 nm to 1360 nm; the Short Wavelength (“S”) Band from 1460 nm to 1530 nm; the Conventional (“C”) band from 1530 nm to 1565 nm; the Long Wavelength (“L”) Band from 1565 nm to 1625 nm; the Ultra-Long Wavelength (“U”) Band from 1625 nm to 1675 nm; or any combination thereof.

The link controller 278 manages the link layer protocols and is responsible for framing, addressing, and error detection for data packets being transmitted between the IO port 52 and another link controller connected to the link controller 278, e.g., a UCIe link controller 264 or a memory controller 362. The ELEC-PHY digital layer 248 is responsible for the physical transmission of digital bits between the link controller 278 and the EO PHY analog layer 274, as well as processing link layer information, e.g., Forward Error Correction (“FEC”), generated by the link controller 278 when transmitting the digital bits. For example, the EO PHY digital layer 248 can include a k-channel serializer/deserializer (“SerDes”) configured to serialize/deserialize parallel bits along each of the k channels. The EO PHY analog layer 274 is responsible for converting the serialized data encoded on electronic signals into serialized data encode on optical signals, and vice versa.

FIG. 3B is a schematic diagram depicting an example of an EO physical analog layer 274A of an EO interface protocol 270. The EO PHY analog layer 274A includes a physical analog electrical (“ELEC-PHY”) layer 274A-E and a physical analog optical (“OPT-PHY”) layer 274A-O that are electrically coupled to each other. Particularly, the ELEC-PHY analog layer 274A-E and OPT-PHY layer 274A-E of the EO PHY analog layer 274A each include an RX side and a TX side. The RX side of the EO PHY analog layer 274 is configured to receive multiplexed optical signals, demultiplex the multiplexed optical signals into k optical signals (plus the RX clk signal), and convert these k optical signals into k electronic signals that each include a respective bitstream. The ELEC-PHY digital layer 274D then desterilizes each of these k electronic into k data buses (parallelized data). The TX side of the EO PHY analog layer 274 performs the opposite. The TX side of the EO PHY analog layer 274 is configured to receive k electronic signals (plus the TX clk signal) that each include a respective bitstream, convert these k electronic signals into k respective optical signals, and then multiplex these k optical signals into a multiplex optical signal.

### For RX

The ELEC-PHY analog layer 274A-E includes k+1 transimpedance amplifiers (“TIAs”) 273-1 to 273-k and 273-clk, while the OPT-PHY analog layer 274A-O includes an optical demultiplexer (“DEMUX”) 271RX, k+1 photodetectors 271-1 to 271-k and 271-clk, an input optical waveguide 64, and k+1 optical waveguides 44-1 to 44-k and 44-clk.

The input optical waveguide 64 connects the optical input port 54 to an input of the DEMUX 271RX. The optical waveguides 44 connect a corresponding output of the DEMUX 271RX to a corresponding one of the photodetectors 271.

The optical input port 54 is configured to receive a multiplexed input signal including a respective optical signal at each of k+1 wavelengths λ₁, λ₂, . . . , λₖ, λₖ₊₁. The input optical waveguide 64 transports the multiplexed input signal to the DEMUX 271RX. The DEMUX 271RX then demultiplexes the multiplexed input signal into each of the k+1 optical signals that are individually transported along the optical waveguides 44 to the photodetectors 271 to be detected in the form of a respective electronic signal. For example, each photodetector 271 can be a photodiode, e.g., a high-speed photodiode. The TIAs 273 are each electrically connected to a corresponding one of the photodetectors 271 and are configured to amplify the detected electronic signals to a suitable level that can be read out by the ELEC-PHY digital layer 248.

### For TX

The ELEC-PHY analog layer 274A-E includes k+1 modulator drivers 275-1 to 275-k and 275-clk, while the OPT-PHY analog layer 274A-O includes a (k+1)-lambda laser light source 40, a DEMUX 271TX, k+1 optical modulators 276-1 to 276-k and 276-clk, a feeder optical waveguide 42, k+1 optical waveguides 46-1 to 46-k and 46-clk, an optical multiplexer (“MUX”) 277TX, and an output optical waveguide 66.

The feeder optical waveguide 42 connects an output of the laser light source 40 to an input of the DEMUX 271TX. The optical waveguides 46 connect a corresponding output of the DEMUX 271TX to a corresponding input of the MUX 277TX. The optical modulators 276 are each positioned on a corresponding one of the optical waveguides 46 to modulate a carrier signal transported along the optical waveguide 46. For example, each optical modulator 276 can be electro-absorption modulator (“EAM”), ring modulator, a Mach-Zehnder modulator, or a quantum-confined Stark effect (“QCSE”) electro-absorption modulator. The output optical waveguide 66 is connects an output of the MUX 277TX to the optical output port 56.

The laser light source 40 is configured to generate the k+1 different wavelengths λ₁, λ₂, . . . , λₖ, λₖ₊₁ of laser light in the form a multiplexed source signal. For example, the laser light source 40 can be a distributed feedback (“DFB”) laser array, a vertical-cavity surface-emitting laser (“VCSEL”) array, a multi-wavelength laser diode module, an optical frequency comb, a micro-ring resonator laser, a multi-wavelength Raman laser, an erbium-doped fiber laser (“EDFL”) with multiple filters, a semiconductor optical amplifier (“SOA”) with an external cavity, a monolithic integrated laser, or a quantum cascade laser (“QCL”) array.

The multiplexed source signal is transported along the feeder optical waveguide 42 to the DEMUX 271TX. The DEMUX 271TX then demultiplexes the multiplexed source signal into a respective optical signal at each of the k+1 wavelengths that are individually transported along the optical waveguides 46 to the MUX 277TX. The modulator drivers 275 are each electrically connected to a corresponding one of the optical modulators 276 and are configured to drive the optical modulators 276 in accordance with the electronic signals generated by the ELEC-PHY digital layer 248. This imparts a respective bit stream onto each of the k+1 optical signals. The MUX 277TX then multiplexes the k+1 optical signals into a multiplexed output signal that is transported by the output optical waveguide 66 to the optical output port 56.

FIG. 3C is a schematic diagram depicting another example of an EO interface protocol 270FO including multiple optical IO ports 52-1 to 52-B. The EO interface protocol 270 described above can be modified to increase bandwidth via fanout of the IO ports 52, which is provided by the modularity of the EO interface protocol 270. Here, the “fanout” EO interface protocol 270FO is configured to generate k WDM data channels at each IO port 52-1 to 52-B. As shown in FIG. 3C, the EO interface protocol 270FO includes B copies of the EO PHY analog layer 274A-1 to 274A-B which increases the effective bidi bitrate that is supported by the EO interface protocol 270FO by a factor of R→BR without increasing the number of individuals wavelengths. Here, the EO PHY digital layer 248 proceeds as above but serializes/deserializes parallel bits along kB channels. For example, the EO PHY digital layer 248 can now include a kB-channel SerDes configured to serialize/deserialize parallel bits along each of the kB channels. Each type of module 22, 32, and 33 can be configured with the EO interface protocol 270FO to vary its number of IO ports 52 as desired.

### V. Examples of Memory Read and Write Request Circuits

FIG. 4A is a schematic diagram depicting an example of a memory read request circuit 400R implemented on a memory module 32 for performing rank interleaving during memory read requests of the memory 34. The memory controller 362 receives single read, single write, burst read and burst write commands, e.g., from a compute module 22 on a XPU 20. The memory controller 362 converts the commands into control and data signals that are driven on a chip-to-chip interconnect from the EO memory interface 36 to the memory 34's memory devices, e.g., that are within about 20 millimeters (“mm”) or less from the EO memory interface 36. The memory ranks 342 are interleaved which means that consecutive addresses are directed to different memory ranks 342. Here, the memory ranks 342 are grouped into M subsets, e.g., 2, 4, 8, 16, or more subsets, that each include D memory ranks 342, e.g., 2, 4, 8, 16, 32, or more memory ranks 342.

Rank interleaving helps to increase the total page size by adding the page sizes the D memory ranks 342 in a subset. Here, the control bus is clocked at a clock rate off on both falling and rising edges yielding 2f per pin. The outputs from the memory ranks 342-1 to 342-D of each group are multiplexed via a D:1 MUX 410. The data bus width per channel is b bits, e.g., 32, 64, or 128 bits, and the memory controller 362 controls M channels. Each channel can be run in lock-mode thus increasing the effective bus width to 2b bits. The net unidi bandwidth from the M channels is 4 Mfb which gives a bidi bitrate of R=2 Mfb/k. At every clock cycle, the memory controller 362 sends the received 4 Mb bits to the EO interface protocol 270 for WDM conversion.

FIG. 4B is a schematic diagram depicting an example of a memory write request circuit 400W implemented on a memory module 32 for performing rank interleaving during memory write requests of the memory 34. The memory write request circuit 400W is configured similarly as the memory read request circuit 400-R except each of the D:1 MUXs 410-1 to 410-M have been replaced with 1:D DEMUXs 420-1 to 420-M and the data flow is in reverse.

FIG. 4C is a schematic diagram depicting another example of a memory read request circuit 401R implemented on a memory module 32 for performing rank sequencing during memory read requests of the memory 34. Here, the memory controller 362 clocks each memory rank 342-1 to 342-r of the memory 34 at a clock rate of f using a clock generation circuit 430, e.g., phase-locked loop (PLL) circuit, a delay-locked loop circuit, a phase-shifting circuit, a digital phase generator, among others. The clock generation circuit 430 imparts a series of phase-shifts of 2π/r to the clock signal to generate a respective clock signal, clk-1 to clk-r, for each memory rank 342-1 to 342-r, that are out of phase with one another, allowing the memory ranks 342 to be accessed by the memory controller 362 in parallel at each clock cycle. The data bus width per memory rank 342 is b=Bk bits, where B is the number of IO ports 52-1 and 52-B, and k is the number of WDM data channels for each IO port 52. The memory controller 362 controls a respective channel for each bit position by combining the output bits of the memory ranks 342 at the bit position. Here, the output bits of the memory ranks 342 at each bit position are combined by a respective mixer 440, giving a bidi bitrate of R=rf/2 for each of the b channels. The b channels are then multiplexed by the multi-port EO memory interface 36FO and output at the IO ports 52-1 and 52-B. Example implementations of this procedure are discussed below for particular types of memory, bandwidth, and capacities.

A typical LPDDR5X device mounted on a DIMM can be clocked at the highest frequency of 8 GHz (4 GHz, dual edges) and the minimum bus width required to achieve 1 Tbps/fiber is 128 bits. However, if also, the maximum bus width per channel used in server systems is 64. Thus, per channel bus bandwidth is limited to 64 GB/sec. If the number of memory channels can be increased and the bus width per channel also can be increased to 256 or 512 bits, channel bandwidth can be increased. However, if the channel width has to be kept at 64 bits (addressable granularity of 64-bit CPUs), the memory bandwidth limitation originates from two sources: (a) the interface clock frequency of the memory device (the speed at which the data is transferred from DDR internal array to the bus), and (b) the copper bus's frequency (determined by the load, trace length and trace width) that runs between the memory controller and memory device. In this invention, we have addressed both the bottlenecks and therefore can increase the bandwidth to 512 GB/sec per 64-bit channel which is 8 times faster compared to the current DIMM implementation. To increase the bandwidth at the interface of the memory device, the 8 GHz clock (125 ps) is phase-shifted by 15.6 ps (22.5 degrees) eight times (using a delay-locked loop circuit) and these phase-shifted clocks are used to clock and read/write eight (8) independent memory devices stacked next to each other in parallel. The data read out of the 8 devices are combined using an asynchronous arbiter circuit to generate a single waveform that has a data rate of 64 Gbps. Thus, without using a 64 Gbps clock, we generated a modulated signal at the rate of 64 Gbps. The 64 Gbps signal on each device pin is now modulated directly to one wavelength inside the EO memory interface 36FO. Thus the 64 pins are modulated using 64 wavelengths which in turn are multiplexed into 4 fibers at the rate of 16 lambdas per fiber. The DIMM configuration is formed using four such modules to provide a throughput of 2 TB/sec across 4 channels, each at 64 bits. This is a record-breaking throughput per DIMM for server workloads.

The GDDR6X devices can be clocked at a frequency of 24 Gbps per pin (using PAM4) and GDDR7 devices can be clocked up to 32 Gbps (using PAM3) and these devices come at 32-bit bus width. Four such devices can ne clocked using four phase-shifted clock signals with 10 ps phase shift and their outputs are combined using an asynchronous arbiter to form the final 96 Gbps or 128 Gbps signal which is then modulated on 32 wavelengths on two fibers (16 per fiber) at a modulation rate of 96 or 128 Gbps/wavelength thus resulting in a 400 GB/sec or 512 GB/sec bandwidth per module. The additional latency suffered due to the EO memory interface 36FO is within 10 ns compared to the electrically connected DIMM and therefore the net latency to the DIMM is 70 ns. Using eight such modules in DIMM results in an 8-channel configuration with 32 bits/channel, a bandwidth of 3.2 TB/sec, or 4 TB/sec with 16 fiber outputs.

### Examples of Electro-Optical Computing Systems

FIG. 5A is a schematic diagram depicting an example of an EO computing system 10 includes a number (c) of XPUs 20-1 to 20-c, a number (m) of MEMs 30-1 to 30-m, and an optical switch 50. Each XPU 20-1 to 20-c includes p compute modules 22-1 to 22-p. Each MEM 20-m to 20-m includes d memory modules 32-1 to 32-d and a primitive execution module 33. Thus, the total number of compute modules 22 is equal to N_{c}=cp, the total number of memory modules 32 is equal to Nₘ=dm, and the total number of primitive execution modules 33 is equal to m. Here, each module 22, 32, and 33 of the EO computing system 10 has a single IO port 52. The optical switch 50 includes a respective IO port 52 for each IO port 520 of the modules 22, 32, and 33. Thus, the total number of IO ports 52 on the optical switch 50, i.e., the radix of the optical switch 50, is equal to N_{c}+Nₘ+m. For example, for c=8, p=256, m=256, and d=8, the optical switch 50 has a switch radix of 4352.

In more detail, the optical switch 50 is optically coupled between each of the XPUs 20-1 to 20-c and each of the MEMs 20-1 to 20-m via optical fiber. As shown in FIG. 5A, the optical switch 50 includes a first set of IO ports 52 adjacent the XPUs 20-1 to 20-c and a second set of ports 52 adjacent the MEMs 30-1 to 30-m. Each IO port 52 of the first set is connected to a corresponding one of the IO ports 52 of the N_{c} compute modules 22 via a pair of optical fibers 12. Particularly, an input optical fiber 14 connects the output Similarly, each IO port 52 of the second set is connected to a corresponding one of the IO ports 52 of the Nₘ memory modules 22 and m primitive execution modules 33 via a pair of optical fibers 12. Each pair of optical fibers 12 includes a respective input optical fiber 14 and a corresponding output optical 16. The input optical fiber 14 connects the output port 56 of the corresponding module 22, 32, or 33 to the corresponding input port 54 of the optical switch 50. The output optical fiber 16 connects the input port 56 of the corresponding module 22, 32, or 33 to the corresponding output port 54 of the optical switch 50.

IO ports 52 of the optical switch 50 that are connected to the compute 22 and memory 33 modules allow full bidi WDM switching. That is, the optical switch 50 can direct any k WDM channel (plus the clk signal if included) from the IO port 52 of any compute module 22 to the IO port 52 of any memory module 32, and vice versa. IO ports 52 of the optical switch 50 that are connected to the primitive execution modules 33 are identified as DarkGreyPorts which have full bidi WDM switching between the primitive execution modules 33 of the MEMs 30 to perform various communication collective operations on the XPUs 20 via shared memory.

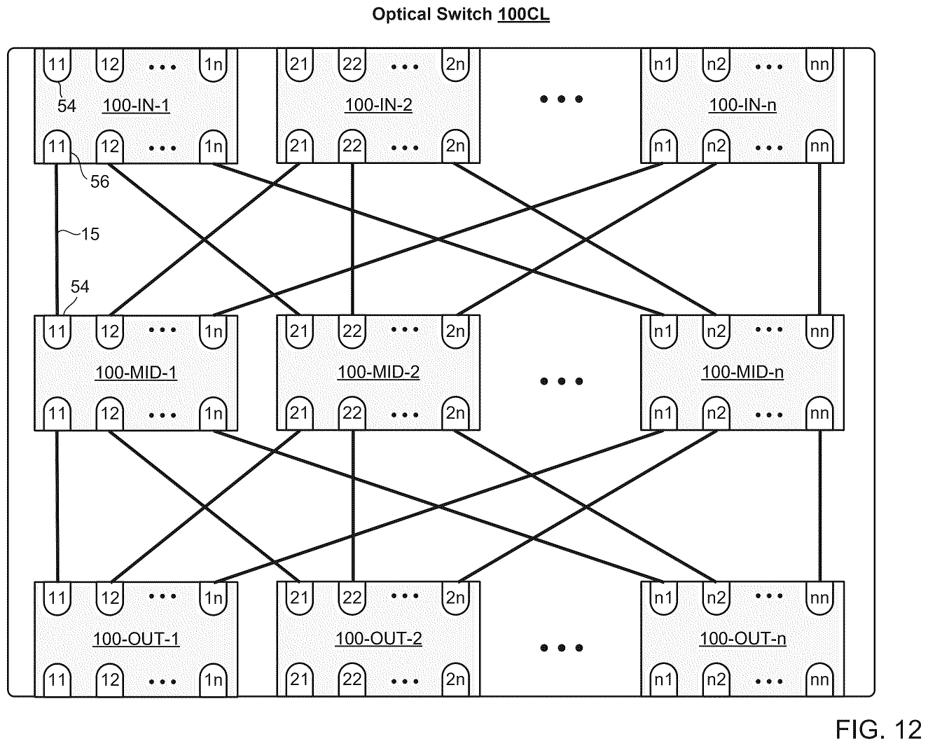

In some implementations, the total number of compute 22 and memory 32 modules is the same N_{c}=Nₘ=n, thus the optical switch 50 can be a symmetric switch with respect to the compute 22 and memory 32 modules and operates similarly to a bidi crossbar switch but with WDM. FIGS. 5B-5D show different layers (or modes) of the optical switch 50 of the EO computing system 10 in such a symmetric configuration. FIG. 5B is a schematic diagram depicting an example of the EO computing system 10 in transmission (“TX”) mode, FIG. 5C is a schematic diagram depicting an example of the EO computing system 10 in receive (“RX”) mode, and FIG. 5D is a schematic diagram depicting an example of the EO computing system 10 in primitive (“PRM”) mode. As shown in FIGS. 5B-5D, the optical switch 50 can include three separate optical switches 100-1, 100-2, and 100-3 that are each implemented as respective layers of the optical switch 50, e.g., stacked on top of one another. Optical switch 100-1 is a unidi switch that allows WDM switching of optical signals generated by the compute modules 22 and received by the memory modules 32. Similarly, optical switch 100-2 is a unidi switch that allows WDM switching of optical signals generated by the memory modules 32 and received by the compute modules 33. Finally, optical 100-3 is a single-sided switch such that the input 54 and output 56 ports for the primitive execution modules 33 are mutually connected to each other. Example topologies of the optical switch 100 are described in more detail below with reference to FIGS. 7-12. Many different topologies of the optical switch 50 can be implemented using multiple optical switches 100 as a building block, see FIG. 12 for example that shows an example of an optical switch 100CL with a Clos network topology.

Note, the number of compute 22 and memory 32 modules can be exceeding large in some cases, e.g., on the order of hundreds, thousands, to tens of thousands. In a complex system with hundreds of tensor cores, the memory requestors or memory agents are statically mapped to memory controllers which in turn are mapped to memory devices. The bandwidth per memory controller is static. However, when the workload changes, the tensor cores require access to different address regions. While addressing the different regions, they also may need higher bandwidths but the memory controller responsible for that region may not need the requirement. To overcome this, the EO computing system 10 uses the optical switch 50 to dynamically map memory channels to memory controllers 362 that have higher bandwidth. For example, if a subset of the memory controllers 362 has particularly high bandwidth, the EO computing system 10 can dynamically allocate bandwidth from the MEMs 30 to these memory controllers 362 with the following variables: (i) increase or decrease the number of memory modules 32 per memory port to satisfy the required bandwidth or required capacity; and (ii) enable or disable shadow mode. Enabling shadow mode increases read bandwidth by reducing bank conflicts.

FIG. 7 is a schematic diagram depicting another example of the EO computing system 10FO with a variable number of IO ports 52 for each type of module 22, 32, and 33, allowing for arbitrary bandwidth fanout. For example, each module 22, 32, and 33 can be configured with the single-ported EO interface protocol 270 or the multi-ported EO interface protocol 270FO. Thus, each module 22, 32, and 33 can include 1, 2, 3, 4, 5, 6, 7, 9, 10, 11, 12, 13, 14, 15, 16, 17, 18, 19, 20, or more IO ports 52. The total number of IO ports 52 for the XPUs 20 is equal to cP≥N_{c}, the total number of IO ports 52 for the MEMs 30 is equal to mM≥Nₘ+m, giving a total number of IO ports 52 for the optical switch 50 of mM+cP. This configuration of the EO computing system 10FO can provide high bandwidth for each XPU 20, e.g., upwards of 4 TB/sec of bandwidth per XPU 20. When mM=cP=n, the optical switch 50FO is symmetric with the respect to the XPUs 20 and the MEMs 30.

The optical switch 50FO is a high radix, WDM-based optical switch fabric. Each IO port 52 of the optical switch 50FO can support multiple wavelengths, e.g., 2, 4, 8, 16, 32, or 64 wavelengths, each wavelength modulated with a high-speed data signal, e.g., a 64 to 100 Gbps data signal. Thus, each IO port 52 of the optical switch 50FO can have bandwidth ranging from about 1 Tbps to 6.4 Tbps. The radix of the optical switch 50FO can be as high as 16K or more, e.g., providing a bisection bandwidth of 8 Pb/s to 51 Pb/s, or more. Moreover, each of the XPUs 20 and MEMs 30 can have flexible bandwidth allocated by connecting a variable number of IO ports 52 to each module 22, 32, and 33 of the circuit packages 20 and 30.

The memory interconnect architecture of the optical switch 50FO allows all-to-all connection between the XPUs 20 and MEMs 30. “All-to-all connection” means the switching latency between any two IO ports 52 is the same for all the IO ports 52, however, the bandwidth between a pair of IO ports 52 can be different, due to the optical switch 50FO's WDM feature. As described in more detail below, the optical switch 50FO is programmable such that each XPU 20 can be allocated with variable bandwidth from each MEM 30 connected, but at the same latency. As one example, for c=8, p=32, m=32, d=8, and M=10, the radix of the optical switch 50FO is equal to 576, the number of compute 22 and memory 32 modules is the same N_{c}=Nₘ=256, and each compute module 22 can have a bandwidth of 4 TB/sec or more between its correspond memory module 32. As another example, for c=8, p=32, P=384, m=225, d=8, and M=10 the radix of the optical switch 50FO is equal to 6144 but can support to 32 TB/sec or more memory bandwidth for each compute module 22.

### Operation of the Optical Switch 50FO

Each XPU 20 is coupled to a MEM 30 via the optical switch 50FO either as primary or secondary. A primary XPU 20 of any MEM 30 will have more bandwidth and hence more exclusive IO ports 52 of the optical switch 50FO are allocated while the secondary XPUs 20 are allocated shared IO ports. The MEMs 30 are connected to the optical switch 50FO using three different types of IO ports 52 (shown in FIG. 6):
WhitePort: Dedicated IO ports 52 of the MEM 30 that are directly connected to the primary XPU 20 via optical fiber and called “remotely local”. The dedicated IO ports 52 can provide extremely high bandwidth (e.g., about 32 TB/sec or more) direct connection between a XPU 20 and MEM 30 at latencies of 70 nanoseconds (“ns”) or less. This is equivalent to the local memory but physically located remotely, hence the name—“remotely local”.
LightGreyPort: Also called Shared Port and is used by secondary XPUs 20 (in shared mode) to access a given XPU 20. If any XPU 20 wants to access any other XPU 20's primary MEM 30, then LightGreyPort is used. Note that the memory access latency is the same for all the XPUs 20 no matter which IO port 52 they are connected to. Thus, for example, if the XPUs 20 want to access the sharded weights from other XPU 20's primary MEM 30, then they can access it as though the weights are being read from its own primary MEM 30.
DarkGreyPort: IO Ports 52 used by the primitive execution modules 33 of the MEMs 30 to perform various communication collective operations on other XPUs 20 via shared memory. This functionality is equivalent to the compute-to-compute communication implemented via IO path which can now happen via shared memory.

The XPUs 20 are connected to the optical switch 50FO in the following ways:
(a) Non-coherent mode where a XPU 20 manages its own last level cache (“LLC”) and all transactions to the shared memory are written back to the MEM 30 by the XPU 20 itself either through flush or write through cache operations.
(b) Coherent mode where the XPU 20 can write its data to the shared memory just to its LLC and it is the responsibility of the MEM 30's cache controller to perform snoop operation to get the latest data copy from the MEM 30's cache. In the coherent mode, the XPU 20's cache controller is connected to the optical switch 50FO.

In a configuration of eight XPUs 20, where each XPU 20 gets 32 TB/sec bandwidth. Apart from the eight IO ports 52 used for dedicated bandwidth, four IO ports 52 are allocated to each MEM 30 for peer-to-peer memory traffic and another four IO ports 52 are allocated to a given XPU 20's cache controller. The cache controller can essentially read values directly from other caches via these IO ports 52. i.e., all the L2/LLC caches of the XPUs 20 are connected via the optical switch 50FO. This is useful when the end point is performing the primitive operations.

The following primitives are realized by the optical switch 50FO: (i) AllGather, (ii) AllReduce, (iii) Broadcast/Scatter, (iv) Reduce, (v) Reduce-Scatter, (vi) Send, and (vii) Receive.

The above primitives are implemented in two ways:
(a) At the end points using a XPU 20's load, store, and ALU instructions. The end point implementation is a simple function call with a sequence of load and store instructions. For AllGather, the loads are done by the XPU 20 from shared memory space through the DarkGreyPort and for Scatter, the stores are done to the same shared memory space (and the DarkGreyPort). Various shared memory spaces are allocated for different thread parallelisms. The load calls to shared space are routed to various MEMs 30 by the address decoder part of the XPU 20. For Reduce-Scatter, the gathered data values are reduced using a XPU 20's ISA and the reduced value is then written back to shared memory space.
(b) At the MEM 30 via the xCCL primitive engine 35. In this case, the XPU 20 offloads the Primitive command to the MEM 30. The execution of the operation begins upon receiving the Global Observation (GO) signal from all the XPUs 20. Essentially, the Primitive Execution Unit (“PEU”) will wait on a list of GO signals from other XPUs 20. The list of GPUs to wait is provided by the topology configuration routine during the run-time initialization from the host CPU.

### Global Observation (GO) Signal Generation and Tracking

The GO signal generation is done by the GOFUB unit within the xCCL primitive engine 35 of each MEM 30. GOFUB continuously monitors any write transaction happening via the memory controller 362 to a specific programmable address space used by the run-time marked as shared memory (“SM”). If a write happens to any address in the SM address space, a GO signal is triggered to all the XPUs 20 connected via the optical switch 50FO.

Similar to generation of the GO signal, the GOFUB also monitors the GOFUB signal triggered by other XPUs 20 via the optical switch 50OF. In the non-coherent connection, each XPU 20 is expected to flush its internal cache to the EO host interfaces 26 (write back) before sending the Primitive Instruction/Command. XPU 20 writes the computed values to L2/LLC (multiple cache lines). Trigger writeback of the cache lines (trigger write back to the memory controller) or enable write through during data store instruction. For example, using ‘st.wt’ instruction from NVIDIA® Parallel Thread Execution (“PTX”) ISA will indicate the cache controller to write through the data (copy held both in the cache hierarchy and memory). This write through transaction will appear at the memory controller interface of the primary MEM 30 mapped to the XPU 20. The GOFUB unit further shall trigger a GO signal through the optical switch 50FO to other XPUs 20 indicating that the XPU 20 write through is complete.

### Shadow Mode Operation

Shadow mode of the optical switch 50FO is enabled by making two or more of memory modules 32 on the same MEM 30 connected to the optical switch 50FO switch run in lock mode. When two memory modules 32 are locked, then, during the write cycle, the same data is written into the memory 34 of each memory module via the EO memory interface 36. Thus, the memories 34 of these two memory modules 32 shall contain identical data. Now, the memory port wants to read from two address spaces A &B mapped to this MEM 30, then reads to the address space B is routed to memory module B and reads from address space A is routed to memory module A thereby doubling the read bandwidth. To summarize, during the write cycle, duplicate write of the same data happens to each memory channel that participates in the shadow mode, and during the read cycle, a read command will be issued to only one of the memory channels based on whether a bank conflict exists or not. The read completion received by each of the memory controllers 362 of the memory modules 32 is coalesced before returning to the requestor. Higher read speed-up can be achieved if the duplication count is increased. For example, to achieve 3× read speedup, for X amount of data, the data can be duplicated using 3 DIMMs. However, after a certain point, diminishing returns is expected. The increase in bandwidth is essentially free as fiber data duplication via a configurable optical switch comes has zero latency cost. Earlier in the electrical domain, duplication increased both latency (mux/demux) and power. For example, if a read operation RE1 has occupied R0 row of B0 bank of Channel 0 and if a new read operation RE2 wants to access a different row, say R1 of B0 bank, we detect a bank conflict. In this case, the read command RE2 will be issued to the memory device of Channel 1 so that RE2 can progress in parallel to RE1. Since the data is duplicated, the data returned by RE2 will be the same as the R1 device's content.

### VI. Examples of Optical Switches

FIG. 7 is a schematic diagram depicting an example of an optical switch 100A based on wavelength-selective filters. The optical switch 100A includes optical filters 102, input optical waveguides 104, secondary optical waveguides 106, optical input ports 54, multi-wavelength mixers 112, output optical waveguides 114, and optical output ports 56. A filter 102 may also be referred to as a “switch” and is labelled as “S” in the figures for brevity. A filtering mechanism of the optical switch 100A is based on the operation of the filters 102. The optical switch 100A is an integrated photonic device that uses the filters 102 to route, based on a wavelength of an optical signal, the optical signal from an input port 54 to one or more of the output waveguides 114. For example, the input ports 54 receive multiple-wavelength multiplexed signals, and the optical switch 100 selectively and independently delivers each multiplexed signal to one of the four output waveguides 114.

The filters 102 are arranged into filter arrays 110. Topologically, each filter array, e.g., filter arrays 110-1, 110-2, to 110-n, is a two-dimensional array, e.g., includes columns and rows. In this example, there are as many channels as there are rows and columns in each filter array 110, that is, there are n channels (wavelengths) and n rows and n columns in each filter array 110. Here, filters 102 in the filter arrays 110 are indexed according to the tensor representation Sabc where a is the input index, b is the output index, and c is channel index.

The input ports 54 receive multiplexed input optical signals having multiple channels, e.g., n multiplexed input optical signals each having k=n channels. The input ports 54 are coupled to the input waveguides 104, which transmit the optical signals to the top row in the filter array 110-1. The waveguides 104 and 106 connect filters 102 in adjacent columns and rows. Input waveguides 104 correspond to the columns, e.g., input waveguide 104-1 connects filters S111-S1nn, which are in the same column and adjacent rows. Secondary waveguides 106 correspond to the rows, e.g., secondary waveguide 106-1-1 connects filters S111-Sn11, which are in the same row and adjacent columns.

Within each filter array 110, each row includes one filter 102 configured to filter optical signals from a different channel, e.g., redirect an optical signal to a neighboring column if the optical signal has a particular peak wavelength, e.g., is within a particular wavelength range, or direct the optical signal to a neighboring row if the optical signal is outside a particular wavelength range. In this specification, “filtering” refers to coupling an optical signal from one waveguide into another waveguide via a filter 102. In some implementations, there is no more than one filter 102 in each row configured to filter optical signals within a particular wavelength range, and each filter 102 is configured to filter optical signals in a different wavelength range. For example, if there are n input ports 54, there are n−1 filters in each row configured to not filter light, e.g., optical signals, within a particular wavelength range or at least any ranges including wavelengths of the N channels.

In this implementation, there are as many input ports, i.e., n input ports 54-1, 54-2, to 54-n, as there are channels supported by the optical switch 100. For example, in filter array 110-1, the first row, e.g., the top row, includes one filter S111 configured to filter optical signals with a first peak wavelength, e.g., a “λ₁” channel, and n−1 filters S211-Sn11 configured to not filter optical signals with a particular peak wavelength. The second row includes one filter S212 configured to filter optical signals at a second peak wavelength, e.g., a “λ₂” channel, and n−1 filters S112 and S312-Sn11 configured to not filter optical signals with a particular peak wavelength. This continues until the n-th row which includes one filter Sn1n configured to filter optical signal with an n-th peak wavelength, e.g., a “λₙ” channel, and n−1 filters S11n-S11(n−1) configured to not filter optical signals with a particular peak wavelength.

In some implementations, a single column of a filter array 110 can have more than one filter 102 configured to filter light with different peak wavelengths. For example, filter array 110nincludes a filter Snn1 configured to filter the λ₁ channel and another filter Snn2 configured to filter the λ₂ channel. In some implementations, a filter array can have no filters 102 configured to filter optical signals with a particular peak wavelength in a single column. For example, the second column in filter array 110n does not include any filter arrays that are configured to filter light with a particular peak wavelength.

Neighboring filter arrays 110 are connected by the input waveguides 104. For example, n input waveguides 104 connect the bottom row of filter array 110-1 to the top row of filter array 110-2. A super array 120 includes the filter arrays 110 stacked on top of each other, e.g., the n filter arrays 110-1 to 110-n, which are each n×n arrays, form the super array 120, which is a n²×n array. Within each column of the super array 120, there is one filter 102 configured to filter optical signals with each of the peak wavelengths of the n channels, e.g., n filters 102 configured to filter optical signals in total. The n filters 102, e.g., filters S111, S122, and S1nn, that are each configured to filter a different channel are connected serially within a single column of the super array 120. Accordingly, the input waveguides 104 can transmit multiplexed input optical signals to each of the serially arranged filters S111, S122, and S1nn in the leftmost column.

Although FIG. 7 depicts the filters 102 disposed in an equally spaced grid, the filters 102 can be physically disposed in other arrangements. The terms “columns” and “rows” refer to connections between the filters 102, e.g., being coupled to adjacent filters in an array, rather require than exact locations. For example, the length of waveguide sections, e.g., the columns of input waveguides 104 and rows of secondary waveguides 106, between each filter 102 can vary.

Although FIG. 7 depicts each filter array 110 having a similar channel organization, e.g., the first row of each filter array 110 includes a filter 102 configured to filter the λ1 channel, other configurations are possible. For example, the order of the rows can vary.

In the last column of each filter array 110, e.g., the rightmost column in this example, the secondary waveguides 106 connect the filters 102 to a multi-wavelength mixer 112. Each filter array 110 corresponds to a respective multi-wavelength mixer 112, e.g., the filter arrays 110 couple the input waveguides 104 to a corresponding multi-wavelength mixer 112 via n of the secondary waveguides 106. The multi-wavelength mixer 112 is configured to receive and combine multiple optical signals of different wavelengths into a multiplexed output optical signal. Each multi-wavelength mixer 112 is coupled to an output waveguide 114, e.g., there is one multi-wavelength mixer 112 and output waveguide 114 per channel. In some implementations, the multi-wavelength mixer 112 is a passive component, e.g., an arrayed waveguide grating (AWG), a Mach-Zender interferometer (MZI), or a ring-based resonator.

Whether a filter 102 is configured to filter or not filter light with a particular peak wavelength depends on a state of the filter. For example, in a first state, a filter 102 can be configured to filter an optical signal with a peak wavelength, e.g., couple the optical signal from a corresponding input waveguide 104 to a corresponding secondary waveguide 106 based on the wavelength of the optical signal. In a second state, the filter 102 can be configured to not filter an optical signal with a peak wavelength, e.g., not couple the optical signal from a corresponding input waveguide 104 to a corresponding waveguide 106. In other words, when the filter 102 is configured to not filter an optical signal, the optical signal remains in a single column as the optical signal travels through the super array 120. When the filter 102 is configured to filter an optical signal, the optical signal travels from one column to another and eventually to a corresponding mixer 112.

In the example of FIG. 1, the optical switch 100A is an n-ported switch, e.g., has n input ports 54, with n channels at each port 54. To achieve the ability to route an optical signal from any input port 54 to any output waveguide 114, there are n³ filters 102. For example, for a 4-ported switched there are 64 filters, for a 16-ported switch there are 4,096 filters, and for a 64-ported switch there are 262,144 filters. Compared to conventional four-channel switches with the ability to route the signal from any input port to any output port, 64 is a relatively low number for the number of required filters. Similarly, 4096 and 262,144 filters are relatively low numbers for 16- and 64-ported switches.

Advantageously, the optical switch 100A has varied capabilities. Based on the states of the filters 102 in the super array 120, optical signals from any channel input at the input port 54 can be routed to any output waveguide 114, which is not possible in a conventional switch. For example, if an input port 54 receives a multiplexed signal including n optical signals each encoded with the same data but in different channels, the multiplexed signal can be broadcast to all n of the output waveguides 114-1 to 114-n at the same time. As another example, an entire multiplexed signal, e.g., a signal including 4, 16, or 64 channels, can be directed to a single output waveguide 114.

The optical switch 100A can be configured to operate in three different modes, e.g., a first mode supporting 16 channels, a second mode supporting 32 channels, and a third mode supporting 64 channels. This flexibility in operation, e.g., switching between modes based on programming, is another advantage of the optical switch 100A. The number of supported channels can affect the spacing between wavelengths. For example, at 16 channels, the optical switch 100A can support a wavelength spacing of 200 GHz, giving a per wavelength maximum bandwidth of 400 Gbps for non-return-to-zero (NRZ) modulation and 800 Gbps for pulse amplitude modulation 4-level (PAM4) modulation. At 32 wavelengths, the optical switch 100A can support a wavelength spacing of 100 GHz, giving a per wavelength maximum bandwidth of 200 Gbps for NRZ modulation and 400 Gbps for PAM4 modulation. At 64 wavelengths, the optical switch 100A can support 50 GHz spacing, giving a per wavelength maximum bandwidth of 100 Gbps for NRZ modulation and 200 Gbps for PAM4 modulation.

The throughput of the optical switch 100A depends on the coding scheme, e.g., NRZ or PAM4. For example, when using NRZ modulation, each wavelength is modulated at 100 Gbps, and each wavelength is modulated at 200 Gbps when using PAM4 modulation. In some implementations, the input ports 54 are connected to fibers that have a total bandwidth supporting 64 wavelengths, which means that for PAM4 modulation, each input port 54 has a throughput of 64×200 Gbps=12.8 Tbps. Since there can be 64 channels per input port 54, the optical switch 100A can have a bandwidth of 819.2 Tbps, which is on the order of 1 Pbps.

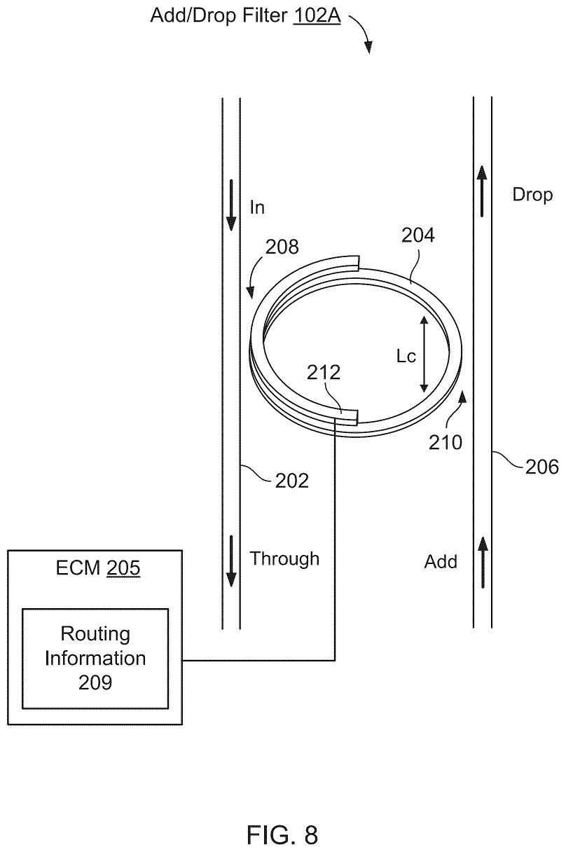

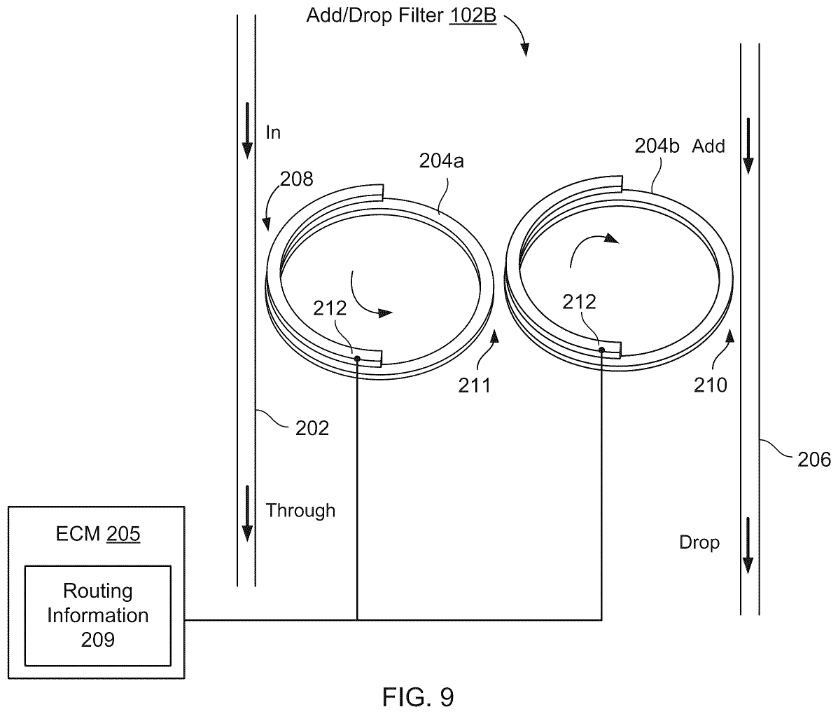

An electronic control module (ECM) 205 (depicted in FIGS. 9A-9B and described below) controls the states of the optical filters 102 in a variety of ways, depending on the mode operation of the optical filters. For example, the ECM 205 can send instructions to heaters that control a temperature of the optical filters 102, which affects the state of the filters 102. In some implementations, each of the filters 102 can be “tuned” to either filter or not filter optical signals in each channel supported by the optical switch 100A. By tuning the filters 102, the optical switch 100A operates to couple an optical signal in a wavelength channel from one waveguide into another waveguide or transmit the optical signal. The description accompanying FIG. 8 will provide more details as to the tuning of the optical states of the optical filters 102.

FIG. 8 is a schematic diagram depicting an example of an add-drop filter 102A based on a ring resonator, e.g., a micro ring resonator (MRR). The add-drop filter 102A includes an input waveguide 202, a ring resonator 124, and a secondary waveguide 106.

As shown, an optical signal travels through the input waveguide 202 and toward a region where the input waveguide 202 is proximate to the ring resonator 204. Light can travel from one waveguide to another when the waveguides are coupled. Placing the ring resonator 204 proximate to the input waveguide 202 provides a coupling region 208. The coupling region 208 is a region where the input waveguide 202 and the ring resonator 204 are sufficiently close to allow an optical signal traveling in the input waveguide 202 to enter the ring resonator 204, e.g., evanescent coupling, and vice versa. Similarly, placing the ring resonator 204 proximate to the secondary waveguide 206 provides the coupling region 210, where optical signals can travel from the ring resonator 204 to the secondary waveguide 206 and vice versa.

Due to a coupling region 208 between the input waveguide 202 and the ring resonator 204 and depending on the wavelength, some of the light enters the ring resonator 204 on the left side of the ring resonator 204. The rest of the light continues to travel through the input waveguide 202. The signal in the ring resonator 204 can travel in a counterclockwise direction until it reaches the other coupling region 210.

At the coupling region 210, depending on the wavelength, some of the light is “dropped,” e.g., exits the ring resonator 204. In some implementations, light is “added” to the ring resonator 204 through an additional port in the secondary waveguide 206. Light added at the additional port travels in the opposite direction through the secondary waveguide 206 compared to light that entered through an input port in the input waveguide 202, because light that is coupled into the ring resonator 204 on the right side of the ring resonator 204 also travels in a counterclockwise direction toward coupling region 208. Then, the “added” light can decouple from the ring resonator 204 and enter the input waveguide 202 through coupling region 208. Both “added” light and light that never entered the ring resonator 204 and just passed through the input waveguide 202 can exit the add-drop filter 102A at an exit port 203.

As an example, when filter 102 is the add-drop filter 102A, optical signals that are filtered can be added to a filter through coupling from input waveguides 104 (input waveguide 202) to the filter 102 and dropped by coupling from the filter 102 to secondary waveguide 106 (secondary waveguide 206). Optical signals that are not filtered can remain in the input waveguide 104 (input waveguide 202) without coupling into the filter 102.

The size, e.g., radius, of the add-drop filter 102A can determine the resonant frequency of the filter. For example, when the circumference of the ring resonator is an integer multiple of a wavelength of light, those wavelengths of light will interfere constructively in the ring resonator 204, and the power of those wavelengths of light can grow as the light travels through the ring resonator 204. When the circumference of the ring resonator is not an integer multiple of the wavelengths of light, those wavelengths of light will interfere destructively in the ring resonator 204, and the power of those wavelengths will not build up in the ring resonator 204.

In some implementations, the radius of the ring resonator 204 is in a range of 50 microns to 200 microns.

Thermal tuning can be used to select which frequencies are added or dropped. For example, the add/drop resonant filter can include a heating element 212, which is thermally coupled to the ring resonator 204. For example, changing the temperature of the ring resonator 204 can increase the resonant frequency. An electronic control module (ECM) 205 is coupled to the heating element 212 to control the state of the add/drop filter 102A, e.g., whether it is tuned to filter or not filter light with a particular peak wavelength. The ECM 205 communicates with the heating element 212 by sending electronic signals, e.g., routing information 209. For example, the routing information 209 includes instructions to activate individual filters 102 or maintain inactivated states. When activated, a filter 102 is configured to couple an optical signal from an input waveguide 104 to a secondary waveguide 106 (filtering). When inactivated, a filter 102 is configured to couple an optical signal from an input waveguide 104 to another input waveguide (not filtering).

The heating element 212 is disposed on top of the ring resonator 204. The heating element 212 has a shape that at least partially matches a shape of the ring resonator 204. For example, the heating element 212 can be a semicircle, as depicted in FIG. 8. The heating element 212 applies heat to the ring resonator 204 by supplying an electric current. The routing information 209 includes instructions for the heating element 212 to control what wavelengths of optical signals are filtered based on the resonant wavelength of the optical filter, which is temperature dependent. The ECM 205 can update the routing information 209, e.g., provide new routing information 209, to the heating element 212 to change a state of the filter 102, e.g., change which channels are filtered. In some implementations, the ECM 205 can update the routing information on intervals on the scale of microseconds. Although this example includes a heating element 212, cooling elements or general temperature control elements are possible.

The coupling strengths at coupling regions 208 and 210 can determine how much of light within the ring resonator 204 couples into or out of the ring resonator 204. For example, the coupling strength can be selected to permit a steady state to build up within the ring resonator 204 by in-coupling and out-coupling a predetermined percentage of light at specific wavelengths. The coupling strengths at the coupling regions 208 and 210 can depend on the material and geometrical parameters of the add-drop filter 102A. The wavelength dependence on light's behavior at the coupling regions 208 and 210, e.g., whether light enters or exits the ring resonator also depends on the material and geometrical parameters of the add-drop filter 102A.

In some implementations, the add/drop filter can be a higher-order resonant filter. The order of the resonator is the number of ring resonators between the first and second waveguide. For example, FIG. 9 depicts a second order add-drop filter 102B, which includes two ring resonators 204. The add-drop filter 102B includes many of the same components as add-drop filter 102A of FIG. 8, and repeated description of these components is omitted. In some implementations, a higher-order resonant filter can be more efficient, e.g., cause less loss, than a first-order resonant filter.

In addition to the coupling 208 between the input waveguide 202 and the first ring resonator 204a and the coupling 210 between the secondary waveguide 206 and the second ring resonator 204b, there is also a coupling 211 between the first and second ring resonators 204a and 204b. Due to this coupling, an optical signal traveling in counter-clockwise direction in the first ring resonator 204a enters the second ring resonator 204b and travels in a clockwise direction. Similarly, an optical signal traveling in clockwise direction in the second ring resonator 204b enters the first ring resonator 204a and travels in a counterclockwise direction. Accordingly, the path of an optical signal from the input waveguide 202 to secondary waveguide 206 and vice versa can follow an S-shaped path.

In some implementations, the ring resonators 204 have different geometries than those presented in FIGS. 9A and 9B. For example, the ring resonators can have elliptical shapes or other geometries. More details on ring resonators can be found in U.S. application Ser. No. 18/460,477, which is hereby incorporated by reference.

The ring resonator 204 can include a core layer, which can be a patterned waveguide. The core layer can be clad with two dielectric layers. A substrate can be in contact with the bottommost dielectric layer and support the core layer and the two dielectric layers. Heating element 212 can be disposed on the topmost dielectric layer. The add/drop filters 102A and 102B can be fabricated in a manner compatible with conventional foundry fabrication processes.

The materials making up add/drop filters 102A and 102B can vary. Each of the input waveguide 202, the ring resonator 204, and the secondary waveguide 206 can include a nonlinear optical material, such as silicon, silicon nitride, aluminum nitride, lithium niobate, germanium, diamond, silicon carbide, silicon dioxide, glass, amorphous silicon, silicon-on-sapphire, or a combination thereof. In some implementations, the core layer is silicon nitride with patterned doping. In some implementations, the two dielectric layers include silicon dioxide.

In some implementations, the heating element 212 includes metal. In some implementations, the heating element 212 is a resistive heater formed in the core layer, e.g., carrier-doped silicon. In some implementations, the heating element 212 is generally disposed adjacent, e.g., next to, below, in contact with, to the ring resonator 204. In some instances, the resonator resonance tuning can be done with other approaches, such as the electro-optic effect, free-carrier injection, or microelectromechanical actuation.

In some implementations, various elements of the device, e.g., the input waveguide 202, the ring resonator 204, the secondary waveguide 206, and the heating element 212 are integrated onto a common photonic integrated circuit by fabricating all the elements on the substrate.

The strength of the couplings in the coupling regions 208 and 210 depend on various factors, such as a distance between the input waveguide 202 and the ring resonator 204 and the distance between the ring resonator 204 and the secondary waveguide 206, respectively. The radius of curvature, the material, and the refractive index of the ring resonator 204 can also impact the coupling strength. Reducing the distance between the heating element 212 and the core layer can increase the thermo-optic tuning efficiency. For example, 0.1% or more of light (e.g., 1% or more, 2% or more, such as up to 10% or less, up to 8% or less, up to 5% or less) can be incoupled into the ring resonator 204, the secondary waveguide 206, and the input waveguide 202.

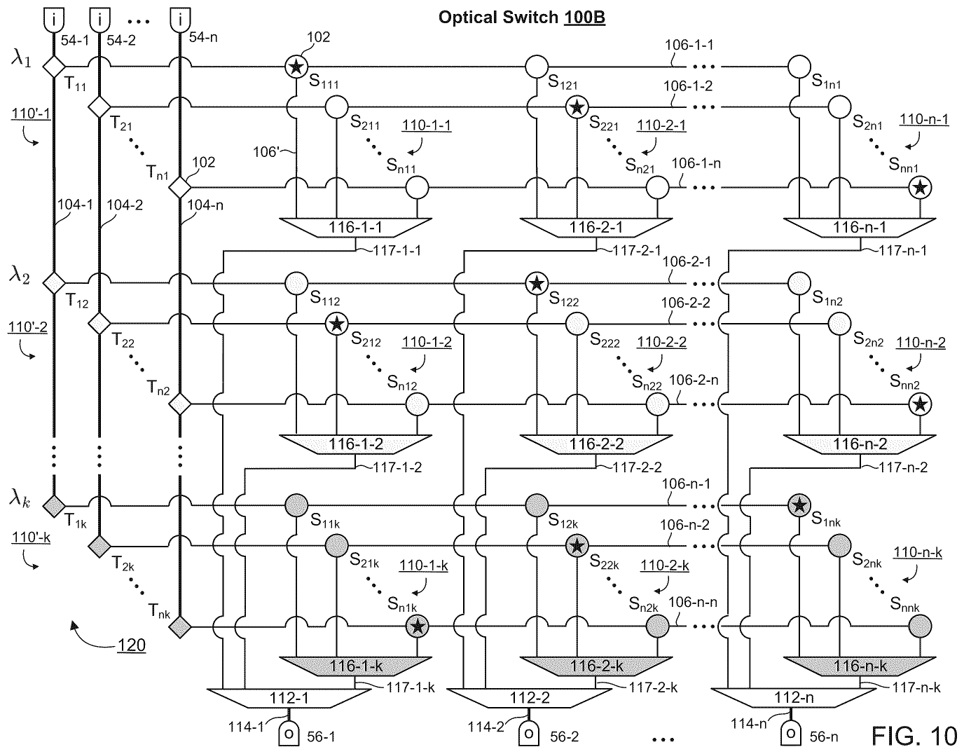

FIG. 10 is a schematic diagram depicting another example of an optical switch 100B based on wavelength-selective filters. The optical switch 100B includes filters 102 arranged in filter arrays 110, input waveguides 104, secondary waveguides 106, input ports 52, multi-wavelength mixers 112, output waveguides 114, and channel mixers 116.

Compared to the optical switch 100A of FIG. 7, the filters 102 in the filter arrays 110 are grouped by the peak wavelengths associated with the filters. For example, filter arrays 110′-1 to 110′-k can be referred to as principal filter arrays, since for each channel, these are the principal filter arrays that will filter an optical signal coming from the input ports 54 for each channel. For clarity, filters in principal filter arrays are labelled with “T” and are identified with the tensor index Tac, where a is the input index and c is channel index as above. In this example, for k channels and n inputs, the filters 102 are arranged in nk+k filter arrays 110.

Each filter 102 in the principal filter arrays 110′-1 to 110′-k is configured to filter an optical signal with a particular peak wavelength. For example, each filter 102 in principal filter array 110′-1 is configured to filter optical signals in the λ₁ channel and pass optical signals in the λ₂, . . . , λₙ channels. Each filter 102 in the principal filter array 110′-2 is configured to filter optical signals in the λ₂ channel and pass optical signals in the λ₁, λ₃, . . . , λₙ channels, and so on. Similarly to the configuration in FIG. 7, each column includes exactly one filter 102 per channel configured to filter optical signals within that channel.

Compared to FIG. 7, instead of being depicted as a matrix, the filter arrays 110 are depicted as diagonal arrays. The input waveguides 104 are arranged in columns for the principal filter arrays 110′-1 to 110′-k and connect the filters 102 in a super array 120 that includes the principal filter arrays 110′-1 to 110′-k. Secondary waveguides 106 connect the principal filter arrays 110′-1 to 110′-k to the remaining filter arrays, e.g., connecting filters 102 in first filter arrays 110-1-1 to 110-1-k, to filters 102 in second filter arrays 110-2-1 to 110-2-k, and so on to the n-th filter arrays 110-n-1 to 110-n-k. The input waveguides 104′ can be coupled to the secondary waveguides 106 or form a continuous waveguide.

Within each first filter array 110-1-1 to 110-1-k, one filter 102 is configured to filter wavelengths with the same peak wavelength as in the corresponding principal filter arrays 110′-1 to 110′-k. For example, in first filter array 110-1-1, filter S111 is configured to filter optical signals in λ₁ channel, while the remaining filters 102, e.g., n−1 filters, in filter array 110-1-1 are configured to not filter optical signals in any channel, and all the filters 102 in filter array 110′-1 are configured to filter optical signals in the λ₁ channel. Similarly, within the second filter arrays 110-2-1 to 110-2-k to the n-th filter arrays 110-n-1 to 110-2-k, one filter 102 is configured to filter wavelengths in the same wavelength as in the corresponding principal filter arrays 110′-1 to 110′-k.

Which filters within the first, second, to n-th filter arrays 110 are tuned to filter optical signals with a particular peak wavelength can be selected such that one and no more than one row corresponding to each channel has a filter 102 configured to filter an optical signal for the respective channel. For example, for the λ₁ channel, filter S111 in filter array 110-1-1, filter S122 in filter array 102-2-2, and filter S1nk in filter array 110-n-k are each configured to filter optical signals in the λ₁ channel. For the λ₂ channel, filter S221 in filter array 110-2-1, filter S212 in filter array 102-1-2, and filter S22k in filter array 110-2-k are each configured to filter optical signals in the λ₂ channel. For the λₙ channel, filter Snn1 in filter array 110-n-1, filter Snn2 in filter array 110-n-2, and filter Sn1k are each configured to filter optical signals in the λn channel. The same pattern applies to the remaining channels, although the order of which row has a filter configured to filter optical signals that a particular peak wavelength varies.

Each row connects n+1 filters 102. Each row includes two filters in a first state where the filter is configured to filter optical signals in one channel, e.g., row 103a includes a filter 102 in the first filter array 110e and a second filter 102i in the second array 110i.

Each of the first, second, to n-th filter arrays 110 is connected to a corresponding channel mixer 116. For example, the n filters 102 in first filter array 110-1-1 all feed, via secondary waveguides 106′, into a channel mixer 116-1-1 (e.g., “λ₁ mixer”), which is configured to combine signals in the λ₁ channel. Since each of the filters 102 in the first, second, to n-th filter arrays 110 can be tuned to either filter or not filter optical signals with a corresponding peak wavelength, the channel mixers 116 collect optical signals from the filters 102 tuned to filter optical signals no matter which filter 102 happens to be “on” for a given configuration.

Each of the channel mixers 116 feeds into a corresponding multi-wavelength mixer 112 via waveguides 117, such that each multi-wavelength mixer 112 receives optical signals from each channel. In this example, there are k channels, such that k channel mixers 116 feed into a single multi-wavelength mixer 112, e.g., channel mixers 116-1-1 to 116-1-k feed into multi-wavelength 112-1.

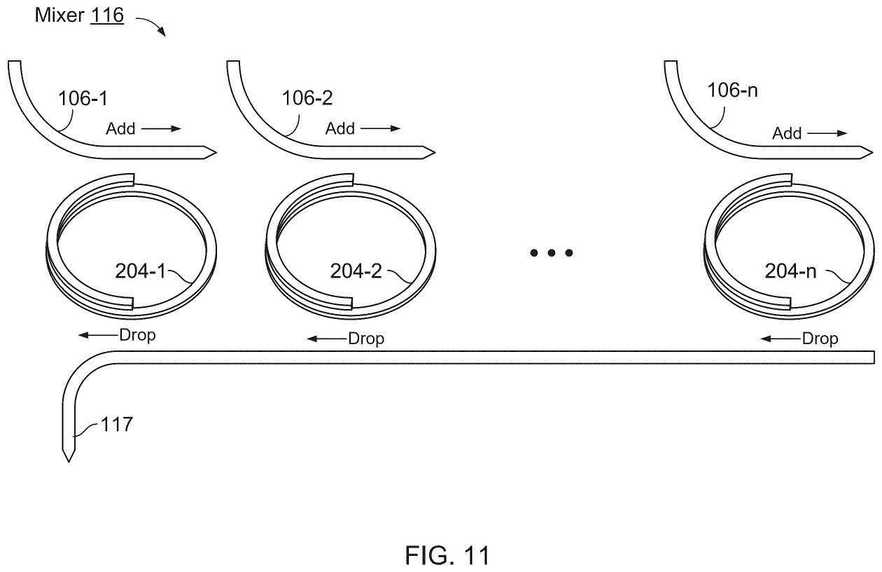

In some implementations, the channel mixers 116 are ring mixers. With reference to FIG. 11, an example of a channel mixer 116 includes n ring resonators 204-1 to 204-1. Each ring resonator 204 is coupled to a respective secondary waveguide 106, each of which is coupled to a filter 102 from a corresponding filter array 110. For example, if the channel mixer of FIG. 11 is channel mixer 116-1-1, and the n secondary waveguides 106 are the secondary waveguides 106′ coupled to the filters 102 from filter array 110-1-1.

The ring resonators 204 can be configured to in-couple optical signals traveling from the secondary waveguides 106, e.g., “add” those optical signals, and out-couple the optical signals into the waveguide 117, e.g., “drop” those signals. In some implementations, only one ring resonator 204 within the channel mixer 116 is configured to add/drop optical signals in a corresponding channel to reduce the likelihood of interference from neighboring ring resonators 204.

In the arrangement of FIG. 10, the filters 102 are arranged by their wavelength selectivity. For example, the first N (N being the number of channels, e.g., 4 in this example) rows only include filters 102 tuned to either filter optical signals in the λ₁ channel or not filter any optical signals. Arranging the filters 102 according to their wavelength selectivity can advantageously reduce interference from optical signals with other peak wavelengths. This reduction in interference can make this arrangement suitable for scaling up the optical switch 100B to include a higher number of ports, e.g., 16 or 64.

This arrangement separates the filters 102 according to the wavelength selectivity by having each filter 102 in the primary filter arrays 110′ filter a corresponding peak wavelength. As a result, compared to the arrangement in FIG. 7, there are more filters 102 to achieve the ability of directing an optical signal from any input port 54 to any output waveguide 114. In this example, there are k channels, so there are n²k+nk filters. Accordingly, for an n-channel optical switch 100B, there will be n² more filters for an n-channel optical switch 100A as that shown in FIG. 10. Optical signals that pass through filters 102 that are configured to not filter optical signals within a particular wavelength can still experience some loss, so additional filters can lead to more loss. Additionally, for the optical switch 100B of FIG. 10, since there are n channels, there are n² channel mixers 116. Although not depicted for the sake of simplicity in the figures, each of the filters 102 in FIGS. 8 and 10 can include a heater or some other component for controlling a temperature of the filter, the heater or other component being connected to an electronic control module.

FIG. 12 is a schematic diagram depicting another example of an optical switch 100CL in a Clos network topology. As shown in FIG. 12, multiple optical switches 100 having the basic architecture described above in can be combined to create more complex devices. The Clos network optical switch 100CL is a three-stage, cascaded switch that includes n optical switches 100 in each stage, e.g., optical switches 100A and/or 100B. Each switch 100 is an n-ported switch such that the Clos network optical switch 100CL includes 3n switches 100 and is configured as an n²-ported optical switch. For example, each switch 100 can be a 16-ported wavelength division multiplexing (WDM), 32-radix switch. In some implementations, the Clos network optical switch 100CL can be scaled to 64, 256, 512, or 1024 ported switches. Optical fibers 15 are connected between the input 54 and output 56 ports of the switches 100.

The switches 100 are arranged in three stages, e.g., an ingress stage, a middle stage, and an egress stage. The ingress stage includes switches 100-IN-1 to 100-IN-n, the middle stage includes switches 100-MID-1 to 100-MID-n, and the egress stage includes switches 100-OUT-1 to 100-OUT-n. For the ingress stage, an output port 56 of each switch 100-IN-1 to 100-IN-n is connected to an input port 54 of a respective switch 100-MID-1 to 100-MID-n in the middle stage. In stage MID, an output port 56 of each switch 100-MID-1 to 100-MID-n is connected to an input port 54 of a respective switch 100-OUT-1 to 100-OUT-n in stage MID.

In some implementations, filters within each switch 100 can be “tuned out,” e.g., controlled by the ECM 205 to change the resonant frequency of the filter, which effectively closes the port to the switch 100 and disconnects the switch 100. As a result, the network topology of the switch 500 can depend on the operational parameters of the ECM 205.

### OTHER EMBODIMENTS

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results.

1. A memory module, comprising:
a memory;
an optical IO port; and
an electro-optical memory interface connecting the memory to the optical IO port, the electro-optical memory interface comprising:
a memory controller electrically coupled to the memory; and
an electro-optical interface electrically coupled to the memory controller and optically coupled to the optical IO port, the electro-optical interface configured to:
receive, from the memory controller, a memory data stream comprising data stored on the memory;
encode the memory data stream onto a multiplexed optical signal; and
transmit, at the optical IO port, the multiplexed optical signal encoded with the memory data stream.

2. The memory module of claim 1, wherein the electro-optical interface comprises:
a link controller electrically coupled to the memory controller, the link controller configured to:
receive, from the memory controller, the memory data stream comprising the data stored on the memory; and
apply, to the memory data stream, a link layer protocol associated with the optical IO port of the memory module;
a digital electrical layer electrically coupled to the link controller, the digital electrical layer configured to:
receive, from the link controller, the memory data stream having the link layer protocol applied thereto; and
serialize, in accordance with the link layer protocol, the memory data stream into a respective bitstream for each of a plurality of wavelengths; and
an analog electro-optical layer electrically coupled to the digital electrical layer and optically coupled to the optical IO port, the analog electro-optical layer configured to:
receive, from the digital electrical layer, the bitstreams comprising the data stored on the memory;
encode, for each of the plurality of wavelengths, the respective bitstream onto a respective optical signal having the wavelength;
multiplex the optical signals encoded with the bitstreams into the multiplexed optical signal; and
transmit, at the optical IO port, the multiplexed optical signal encoded with the memory data stream.

3. The memory module of claim 2, wherein the analog electro-optical layer comprises:
an analog optical layer comprising:
an optical multiplexer for multiplexing the optical signals encoded with the bitstreams into the multiplexed optical signal;
an output optical waveguide connecting an output of the optical multiplexer to an output port of the optical IO port; and
for each of the plurality of wavelengths:
a respective optical modulator for encoding the respective bitstream onto the respective optical signal having the wavelength; and
a respective optical waveguide connecting the respective optical modulator to a respective input of the optical multiplexer; and
an analog electrical layer comprising, for each of the plurality of wavelengths, a respective modulator driver electrically coupled to the digital electrical layer and the respective optical modulator in the analog optical layer, each modulator driver configured to drive the respective optical modulator in accordance with the respective bitstream.

4. The memory module of claim 1, wherein the memory comprises a plurality of memory ranks each comprising a plurality of memory chips.

5. The memory module of claim 4, wherein the electro-optical memory interface further comprises:
a plurality of multiplexers each associated with a respective subset of the plurality of memory ranks for multiplexing each memory rank in the subset, each multiplexer comprising:
a plurality of input buses each electrically coupled to an output bus of a corresponding memory rank in the subset of memory ranks for the multiplexer; and
an output bus electrically coupled to the data bus memory controller.

6. The memory module of claim 4, wherein each of the plurality of memory ranks has a respective output bit at each of a plurality of bit positions, and the electro-optical memory interface further comprises:
a clock generation circuit electrically coupled to the memory controller and each of the plurality of memory ranks, the clock generation circuit configured to:
receive, from the memory controller, a reference clock signal; and
impart, for each memory rank, a respective phase shift to the reference clock signal to generate a respective clock signal for the memory rank; and
a plurality of mixers each associated with a respective bit position corresponding one of the plurality of bit positions for combining the output bit of each memory rank at the bit position, each mixer comprising:
a plurality of input bits each electrically coupled to the output bit of a corresponding one of the plurality of memory ranks at the bit position for the mixer; and
an output bit electrically coupled to the memory controller.

7. The memory module of claim 6, wherein the clock generation circuit is a phase-locked loop circuit, a delay-locked loop circuit, a phase-shifting circuit, or a digital phase generator.

8. The memory module of claim 4, wherein each memory chip of each memory rank is a LPDDRx memory chip or a GDDRx memory chip.

9. The memory module of claim 4, wherein the memory comprises eight or more memory ranks, and each memory rank comprises four or more memory chips.

10. The memory module of claim 4, further comprising a printed circuit board having the memory, optical IO port, and electro-optical memory interface mounted thereon.

11. The memory module of claim 10, having a DIMM form factor.

12. The memory module of claim 1, having a bandwidth of 1 terabyte per second (TB/sec) or more.

13. An electro-optical computing system, comprising:
an optical switch comprising a first set of optical IO ports and a second set of optical IO ports, wherein the optical switch is configured to, for each optical IO port in the first set:
receive, at the optical IO port, a respective multiplexed input optical signal comprising a respective optical signal at each of a plurality of wavelengths; and
independently route each optical signal in the respective multiplexed input optical signal to any optical IO port in the second set; and
a plurality of memory modules optically coupled to the optical switch, each memory module comprising:
a memory;
an optical IO port optically coupled to a respective optical IO port in the first set; and
an electro-optical memory interface connecting the memory to the optical IO port of the memory module, the electro-optical memory interface configured to:
generate a memory data stream comprising data stored on the memory;
encode the memory data stream onto the multiplexed input output signal received at the respective optical IO port in the first set; and
transmit, at the optical IO port of the memory module, the multiplexed input optical signal encoded with the memory data stream.

14. The electro-optical computing system of claim 13, wherein:
the optical switch is further configured to, for each optical IO port in the second set:
multiplex each optical signal routed to the optical IO port into a respective multiplexed output optical signal; and
transmit, at the optical IO port, the respective multiplexed output optical signal comprising a respective optical signal at each of the plurality of wavelengths, and
the electro-optical computing system further comprises a plurality of compute modules optically coupled to the optical switch, each compute module comprising:
a host;
an optical IO port optically coupled to a respective optical IO port in the second set; and
an electro-optical host interface connecting the host to optical IO port of the compute module, the electro-optical host interface configured to:
receive, at the optical IO port of the compute module, the multiplexed output optical signal transmitted at the respective optical IO port in the second set;
extract, from the multiplexed output optical signal, a memory data stream comprising the data stored on each memory of a subset of the plurality of memory modules; and
transmit, to the host, the memory data stream comprising the data stored on each memory of the subset of memory modules for the compute module.

15. The electro-optical computing system of claim 14, wherein:
the optical switch is further configured to, for each optical IO port in the second set:
receive, at the optical IO port, a respective multiplexed input optical signal comprising a respective optical signal at each of the plurality of wavelengths; and
independently route each optical signal in the respective multiplexed input optical signal to any one optical IO port in the second first set, and
the electro-optical host interface of each compute module is further configured to:
receive, from the host, a memory request stream comprising requests to access the data stored on each memory of the subset of memory modules for the compute module;
encode the memory request stream onto the multiplexed input optical signal received at the respective optical IO port in the second set; and
transmit, at the optical IO port of the compute module, the multiplexed input optical signal encoded with the memory request stream.

16. The electro-optical computing system of claim 15, wherein:
the optical switch is further configured to, for each optical IO port in the first set:
multiplex each optical signal routed to the optical IO port into a respective multiplexed output optical signal; and
transmit, at the optical IO port, the respective multiplexed output optical signal comprising a respective optical signal at each of the plurality of wavelengths, and
the electro-optical memory interface of each memory module is further configured to:
receive, at the optical IO port of the memory module, the multiplexed output optical signal transmitted at the respective optical IO port in the first set;
extract, from the multiplexed output optical signal, a memory request stream comprising each request to access the data stored on the memory; and
process the memory request stream to generate, responsive to the requests, the memory data stream comprising the data stored on the memory.

17. The electro-optical computing system of claim 16, wherein for each compute module, a latency between the host of the compute module and each memory in the subset of memory modules for the compute module is 70 nanoseconds (ns) or less.

18. The electro-optical computing system of claim 13, wherein the plurality of wavelengths includes 16 wavelengths or more, the optical switch has a radix of 256 or more, the optical switch has a bisection bandwidth of 1 petabit per second (Pbps) or more, and/or the plurality of memory modules has a memory capacity of one terabyte (TB) or more.

19. The memory module of claim 1, wherein:
the multiplexed optical signal is a multiplexed output optical signal,
the electro-optical interface is further configured to:
receive, at the optical IO port, a multiplexed input optical signal encoded with a memory request stream comprising requests to access the data stored on the memory;
extract the memory request stream from the multiplexed input optical signal; and
transmit, to the memory controller, the memory request stream comprising the requests to access the data stored on the memory, and
the memory controller is configured to process the memory request stream to generate, responsive to the requests, the memory data stream comprising the data stored on the memory.

20. The memory module of claim 1, wherein the optical IO port is one of a plurality of optical IO ports of the memory mode, the multiplexed optical signal is one of a plurality of multiplexed optical signals, and the electro-optical interface is further configured to:
encode the memory data stream onto the plurality of multiplexed optical signals; and
transmit, at each of the plurality of optical IO ports, a corresponding one of the plurality of multiplexed optical signals encoded with the memory data stream.
